(19) United States
(12) Patent Application Publication
(10) Pub. No.: US 2021/0335012 A1
(43) Pub. Date: Oct. 28, 2021

(54) TEMPERATURE REFERENCE SYSTEMS AND METHODS THEREOF FOR THERMAL IMAGING

(71) Applicant: MEGA AI Lab Co., Ltd., Seoul (KR)

(72) Inventors: Youngtack SHIM, Seoul (KR); Dongha J. YANG, Seoul (KR)

(73) Assignee: MEGA AI Lab Co., Ltd., Seoul (KR)

(21) Appl. No.: 17/154,510

(22) Filed: Jan. 21, 2021

Related U.S. Application Data
(60) Provisional application No. 63/016,504, filed on Apr. 28, 2020.

(51) Int. Cl. G06T 7/90; G06F 1/20; H04N 5/33

(52) U.S. Cl. CPC G06T 7/90; G06T 2207/10048; H04N 5/33; G06F 1/206

(57) ABSTRACT

The disclosure relates to various temperature reference systems capable of generating at least one reference temperature. Such systems may provide the reference temperature to an IR camera which may then use the reference temperature in measuring a temperature of a target who has an unknown temperature. More particularly, this disclosure discloses various temperature reference units or their pink bodies of which temperature is to be detected and used as the reference temperature by the IR camera, and various configurations and methods of preventing or minimizing inherent errors which are caused by thermal conduction as well as thermal convection on and across such a temperature reference unit. This disclosure also relates to various methods of fabricating, installing, and using the pink bodies, temperature reference units, and temperature reference systems, in conjunction with an IR camera, a processor or other thermal imaging equipment.

### CROSS-REFERENCE TO RELATED APPLICATIONS

This disclosure claims priority from the Provisional Patent Application No. 63/016,504 that is entitled “Temperature reference systems and methods thereof for thermal imaging” and filed on Apr. 28, 2020, which is incorporated herein by reference in its entirety. In case of any discrepancy between this disclosure and the aforementioned Provisional Application, this disclosure shall prevail over the above Provisional Application. It is noted that the contents that was provided in the above Provisional Application but that is not included in this disclosure are deemed to be not incorporated into this disclosure and that such contents are not parts of this disclosure.

### FIELD OF THE DISCLOSURE

This disclosure relates to various temperature reference systems and methods of making or using such temperature reference systems in the field of temperature measurement using infrared (i.e., “IR”) thermal imaging systems. In particular, this disclosure relates to various temperature reference systems [1] which can provide an accurate reference temperature in a narrow range of, e.g., from 30° C. to 42° C., from 36° C. to 42° C., from 36° C. to 40° C., from 38° C. to 40° C., from 36° C. to 39° C., from 37° C. to 39° C., or the like, [2] with which an IR thermal imaging cameras can effectively and accurately calibrating themselves and accurately measure a body temperatures in such ranges, [3] which may be accurate but inexpensive, [4] which may be easy to deploy (or use) but accurate, or [5] which may be cheap and disposable.

This disclosure further relates to a temperature reference system capable of providing a reference temperature [1] which may or may not be a temperature of an ambient air, [2] which may or may not vary due to a change in the temperature of an ambient air, [3] which may be closer to a temperature of a human body of a normal or sick person with a fever or hyperthermia, or [4] which may be easily manipulated, e.g., by a temperature reference system, a user of such a system, an IR thermal imaging camera, a computer, a processor, or an image processing equipment, or the like.

### BACKGROUND OF THE DISCLOSURE

IR thermal imaging cameras include many elements which receive photons or IR rays emitted by a target of a certain temperature. The cameras estimate a target temperature by detecting an amount of photons or IR rays which are emitted by the target and which are then received by the IR thermal imaging cameras.

Cooled IR thermal imaging cameras typically include multiple elements each of which may receive the photons or IR rays. The cooled IR camera then calculates that amount of the photons or the IR rays received over a certain period of time, and directly estimate the target temperature.

Uncooled IR thermal imaging cameras include multiple elements receiving the photons or IR rays as well. For example, a temperature of the element increases or decreases depending on the amount of the received photons or IR rays. The uncooled IR camera then measures changes in an electrical resistance of the element caused by the changes in the temperature of the element. Through this indirect way, the uncooled IR camera measures the temperature of the target based on the changes in the electrical resistance of the element.

Such IR thermal imaging cameras generally suffer from errors in measuring the correct temperature of the target due to limitations which are inherent in at least one element of each camera. Accordingly, such cooled or uncooled IR thermal imaging cameras tend to use a black body which emits photons or IR rays of a known temperature, e.g., a certain temperature selected by a manufacturer or a room temperature. By measuring the amount of photons or IR rays that are emitted by the black body, the cameras can calibrate themselves automatically or manually (by a user).

A human body operates to maintain homeostasis. As a result, the human body temperature varies in a relatively narrow range, e.g., usually around 36.5° C. The body temperature further varies from person to person and, even for the same person, his or her body temperature fluctuates daily.

When the human body temperature increases, e.g., up to 38° C. or 38.5° C., it is called a “fever.” When the body temperature further increases, e.g., up to 38.5° C. or 39° C. or 40° C., it is called “hyperthermia.” The IR thermal imaging cameras have been used to measure the human temperature, e.g., in order to screen those with fever or hyperthermia. However, inherent inaccuracies of the elements in such cameras tend to yield unreliable temperature readings of a target.

A typical black body emits photons or IR rays which represents a fixed reference temperature. But the reference temperature tends to be not close to the human body temperature. For example, when a certain black body is used to provide a reference temperature of 25° C., that reference temperature is 11.5° C. cooler than a normal body temperature such as, e.g., 36° C. or 36.5° C. Thus, this reference may not be effective in compensating for the inherent errors in the IR thermal imaging cameras.

But the human body temperature may vary at most up to 42° C. which corresponds to only a range of 5.5° C. or so from 36.5° C. Although conventional black bodies may still be able to provide a valuable reference to the prior art IR thermal imaging cameras, in many cases, the prior art black bodies may not provide an effective reference when measuring human temperature. In addition, most black bodies are relatively bulky or expensive.

Therefore, there is a great need for IR thermal imaging cameras which can accurately measure the human temperature at least in such a narrow range.

There also is a great need for effectively and accurately calibrating the IR thermal imaging cameras in such a way that the IR cameras can effectively and accurately measure the body temperatures in such a narrow range.

There also is a great need for a temperature reference system for such IR thermal imaging cameras, where the temperature reference system may be accurate but inexpensive, where the system may be easy to deploy (or use) but accurate, or where the system may be cheap and disposable.

There further is a great need for a temperature reference system capable of providing a reference temperature [1] which may or may not be a temperature of an ambient air, [2] which may or may not vary due to a change in the temperature of an ambient air, [3] which may be closer to a temperature of a human body of a normal or sick person with a fever or hyperthermia, or [5] which may be easily manipulated, e.g., by a temperature reference system, a user of such a system, an IR thermal imaging camera, a computer, a processor, or an image processing equipment, or the like.

### SUMMARY OF THE INVENTION

This disclosure relates to various temperature reference systems (to be abbreviated as “temperature ref. systems,” “temp. ref. systems” or simply “systems” hereinafter) capable of providing at least one reference temperature to various photon (or IR ray)-receiving or detecting elements of the IR thermal imaging cameras (to be abbreviated as “IR cameras” hereinafter). As a result, the IR cameras can detect at least one reference temperature provided by the temperature ref. system of this disclosure, and can calibrate readings of the IR cameras based upon the reference temperature(s).

This disclosure relates to various temperature ref. systems each of which can provide the IR cameras with multiple reference temperatures, where such temperature ref. systems can also provide multiple reference temperatures simultaneously, one at a time (or sequentially) or in a combination.

This disclosure relates to various temperature ref. systems capable of providing reference temperatures in such a way that a user of an IR camera can calibrate the IR camera based on one or multiple reference temperatures or that an IR camera can automatically calibrate itself based on one or multiple reference temperatures.

This disclosure relates to various temperature ref. systems which may be used to calibrate the IR thermal imaging cameras without resorting to conventional black bodies.

This disclosure relates to various temperature ref. systems for providing the IR cameras with at least one reference temperature which is closer to the human body temperature.

This disclosure relates to various temperature ref. systems which may provide the IR cameras with at least one reference temperature (to be abbreviated as a “ref. temperature” or a “ref. temp.” hereinafter) which may fall in the range of, e.g., [1] from 34 (or 35°) C. to 42 (or 43°) C., [2] from 35 (or 36°) C. to 41 (or 42°) C., [3] from 36 (or 37°) C. to 40 (or 41°) C., [4] up to 36° C., [5] up to 37° C., [6] up to 38° C., [7] over 38° C., [8] over 39° C., [9] over 40° C., [10] any combination of at least two of the above, [11] any temperature or any temperature range which may be selected by a temperature ref. system, an IR camera, or a user, [12] any other temperature ranges each including therein 36.5 or 37.0° C., or [13] any other temperature ranges each of which may not include therein 36.5° C. or 37° C.

This disclosure also relates to various temperature ref. systems which may include [1] one (i.e., a single) temperature reference unit (to be abbreviated as a “temperature ref. unit,” a “temp. ref. unit,” a “reference unit” or a “ref. unit” hereinafter) to provide an IR camera with one or multiple reference temperatures, [2] multiple temperature ref. units each providing a single reference temperature to the IR camera, [3] multiple temperature ref. units which together provide a single reference temperature to the IR camera, or [4] a combination of the above.

This disclosure further relates to various temperature ref. systems which may include a temperature ref. unit capable of providing an IR camera with multiple (therefore, identical or different) reference temperatures simultaneously (i.e., at the same time), sequentially (i.e., one after another) in a preset order or in a random manner, or the like.

A “target” refers to an object of which temperature is to be measured by the IR camera, where the target may include a human, another living organism, or another non-living object. A “human target” refers to a human who may be healthy, sick, or unknown. Unless otherwise specified, a target is to mean a human target throughout this disclosure.

Unless otherwise specified, “IR rays” collectively refer to [1] IR rays or photons which are emitted by the target or [2] IR rays or photons that are collected by the photon (or IR ray)-receiving element of the IR thermal imaging camera.

An “IR thermal imaging camera” within the scope of this disclosure collectively refer to, e.g., an IR thermal camera, an IR thermal imaging system, or any other imaging cameras or systems capable of generating a thermal image based upon the IR rays which are emitted by a target (or a temperature ref. system) or which are collected by the IR thermal imaging camera. To this end, the IR thermal imaging camera may [1] include at least one IR (or photon)-receiving element therein, [2] detect at least a portion of the IR rays which are emitted by the target (or a temperature ref. system) with the above element, or [3] estimate a target (or reference) temperature based on the amount of the detected IR rays. An IR thermal imaging camera may be abbreviated as an “IR thermal camera” or an “IR camera.”

An “IR camera assembly” refers to an assembly which includes a temperature reference system as well as an IR camera or other prior art thermal imaging equipment. The temperature reference system and the camera may generally be provided as physically separate articles and may be electrically connected to each other. However, the system and the IR camera may be provided as a unitary article, where the system may be affixed to the IR camera or may be detachably coupled thereto.

A “temperature reference unit” refers to a unit which is a part of a temperature reference system, and may be abbreviated as a “temperature ref. unit,” a “temp. ref. unit,” a “reference unit” or a “ref. unit.” A temperature reference unit may perform at least one of the following functions.

For example, a temperature ref. unit may maintain or keep temperature of at least a portion of itself at a preset reference temperature, optionally in a certain range of tolerance, i.e., at the preset ref. temperature±0.1° C., ±0.05° C., ±0.01° C., or the like.

A temperature ref. unit may heat the above portion when the temperature of the portion falls below a reference temperature. To this end, a temperature ref. system may include at least one heating unit capable of heating the above portion of the temperature ref. unit, thereby increasing temperature of such a portion. To this end, a temperature ref. system may include a control unit which may turn on or off the heating unit.

A temperature ref. unit may cool the above portion when the temperature of such a portion increases over a reference temperature. To this end, a temperature ref. system may include at least one cooling unit capable of cooling the above portion of the temperature ref. unit, thereby decreasing temperature of such a portion. To this end, a temperature ref. system may include therein a control unit which may turn on or off the cooling unit.

Within the scope of this disclosure, a “pink body” refers to a certain portion of a temperature ref. unit of which temperature is to be measured by an IR camera. That is, a “pink body” may be deemed as a preset portion of a temperature ref. unit, where the pink body may correspond to a portion which can be seen by an IR camera. In this context, the pink body may correspond to the portion which is exposed to an ambient air, where the portion is located on a second surface or a second interface of the temperature ref. unit as will be explained below.

Various temperature ref. systems may maintain or keep the temperature of the pink body at or near a preset reference temperature such that an IR camera may use the temperature of the pink body as a reference temperature. Therefore, a “pink body” does not necessarily mean that a color of that body is pink.

A temperature ref. unit may designate its specific portion as a “pink body” in such a way that an IR camera may find that portion and use the temperature of that portion as a reference temperature. In contrary, regardless of whether a certain temperature ref. unit may designate a portion as a “pink body,” an IR camera (e.g., its hardware or software) may decide which portion of the temperature ref. unit is to be used when obtaining a reference temperature. In this configuration, an exact location of the pink body is selected by the IR camera.

A computer which may process images captured by an IR camera, a processor which may process such images captured by an IR camera, or other image processing hardware or software capable of processing such images may similarly determine a “pink body” of a certain temperature ref. unit.

It is to be noted that all of the above IR camera, computer, processor or image processing equipment (including its software) are to be collectively referred to as the “IR camera” hereinafter. For example, when an IR camera is linked to such a computer or processor, its computer or processor may identify a predetermined portion of the temperature ref. unit as the pink body, or may select a certain portion of the temperature ref. unit as the pink body. Thereafter, the computer or processor of the IR camera may obtain a temperature of the pink body and then use that temperature as a reference temperature in measuring a temperature of a target.

It is also noted that such computer, processor or image processing equipment may be incorporated into an IR camera or that such computer, processor or image processing equipment may be provided separately from the IR camera (i.e., such computer, processor or image processing equipment are not a part of the IR camera). For the illustration purposes, however, the IR camera of this disclosure may be deemed to collectively refer to such computer, processor or image processing equipment.

Many prior art black bodies may provide the IR camera with a reference temperature which is rather fixed and not changing, regardless of the ambient condition.

In contrary, the term “pink body” is used in this disclosure in order to point out that the pink body can provide an IR camera with a single or multiple reference temperatures, where such reference temperatures may be constant or may be changed by the temperature ref. system, by an IR camera, or by a user.

That is, the temperature ref. unit of the temperature ref. system may provide various reference temperatures to an IR camera, while allowing a user to increase or decrease the reference temperature as the user sees it fit. For example, the reference temperature which is provided by the temperature ref. system to the IR camera can be constant or can be adjusted, e.g., by the temperature ref. system or its user, by an IR camera or its user, by another device which can manipulate the temperature ref. system, an IR camera, or the like.

The temperature ref. system may also provide more useful reference temperature(s) to the IR camera, e.g., by manipulating the reference temperature to be closer to a body temperature of a normal or sick person through, e.g., heating, cooling, or the like.

It is appreciated in this disclosure that, when an IR camera is said to “measure a temperature of a pink body” (e.g., a portion of a temperature ref. unit), an IR camera is deemed to take the following actions. For example, an IR camera may receive IR rays emitted by the pink body, detect the IR rays, measure an amount of the detected IR rays, receive from the temperature reference system a signal which represents a temperature of the pink body measured by a sensing unit, and match the amount with the measured temperature of the pink body. The IR camera may optionally display at least one thermal image according to a preset color coding scheme, where a hot object is represented in red and a cool object is colored in blue, and where a pink body may be included in the image.

It is noted that different thermal imaging equipment may “measure a temperature of a pink body” (or a portion of a temperature ref. unit) in the steps which may be different from those explained in the above paragraph or in a sequence different from that explained in the above paragraph. As long as the equipment measures the pink body temperature by detecting the IR rays or photons emitted by the pink body, however, the steps described in the above paragraph may be generally applied.

It is also noted in this disclosure that, when an IR camera is said to “obtain a reference temperature” and use the reference temperature in measuring (and calibrating) a temperature of a target, the IR camera is deemed to take the following actions.

For example, the IR camera may measure the amount of the detected IR rays as mentioned above, receive from the temperature ref. system the signal which represents the temperature of the pink body measured by the sensing unit, regard the amount of the detected IR rays to correspond to the temperature measured by the sensing unit (e.g., 1-to-1 matching relationship), regard that amount as a reference for the measured temperature (therefore, the reference temperature), and measure and calibrate the temperature of the target using that reference temperature or relationship between the temperature of the pink body measured by the sensing unit and the amount of the IR rays emitted by the pink body and detected by the IR camera.

Accordingly, it is preferred in this disclosure that the amount of the IR rays emitted by the pink body and detected by the IR camera may precisely correspond to the temperature of the pink body which is measured or estimated by the sensing unit. That is, when there exists a discrepancy between the temperature of the pink body measured or estimated by the sensing unit and the temperature which corresponds to the amount of detected IR rays, the IR camera may inevitably introduce errors when measuring the target temperature using the reference temperature.

To minimize such errors, this disclosure provides various configurational or procedural strategies of fabricating, installing or using various temperature reference systems and their units, along with the IR cameras.

Thus, this disclosure provides various configurations or methods of abolishing or at least minimizing such discrepancies or errors by assessing complex heat transfer mechanisms which occur into and out of the pink body and by proactively compensating for such discrepancies or errors. In addition, this disclosure provides various configurations or methods of positioning the sensing unit proximate to the pink body such that the temperature measured by the sensing unit may accurately reflect the amount of the IR rays emitted by the pink body and then detected by the IR camera.

Followings are some examples of IR assemblies of this disclosure, their temperature reference systems, and their IR cameras.

In one example, an IR camera assembly is provided for measuring and calibrating a temperature of a target. The assembly may include a temperature reference system and an IR camera. The system may include at least one sensing unit which measures its temperature and at least a portion of which is exposed to an ambient air. The system may include at least one of a heating unit and a cooling unit disposed close to the sensing unit, where the heating unit may generate heat, deliver the heat to the sensing unit, and increase the temperature of the sensing unit, and where the cooling unit may absorb heat from the sensing unit, and decrease the temperature of the sensing unit, The system may further include a control unit for maintaining the temperature of the sensing unit at a preset temperature by manipulating at least one of the heating and cooling units. The IR camera may detect a first amount of first IR rays emitted by the sensing unit and a second amount of second IR rays emitted by the target. The assembly may obtain a relationship between the first amount of the IR rays and the temperature of the sensing unit, and may determine a temperature of the target from the second amount of the IR rays using the relationship.

At least one of the heating and cooling unit may include a top portion, where the sensing unit may be disposed, e.g., [1] on top of the top portion, where at least a substantial portion of the sensing unit may be exposed to the ambient air, [2] inside a cavity which may be formed in one of the heating and cooling units, where at least a portion but not an entire portion of the sensing unit may be disposed inside the cavity, [3] inside the cavity, where an entire portion of the sensing unit may be disposed inside the cavity.

The preset temperature may fall between a low temperature and a high temperature, where the low temperature may be 35° C., 36° C., 37° C., 38° C., or 39° C., where the high temperature may be 37° C., 38° C., 39° C., 40° C., 41° C., or 42° C., and where the low temperature is less than the high temperature.

The sensing unit may be one of a thermocouple, a thermistor, and a resistance temperature detector. At least one of the heating and cooling units may be a Peltier element.

The assembly may also include an outer layer provided over an outer surface of the sensing unit, and the outer lay has an IR-ray emissivity which may be greater than 0.9 or 0.95. The outer layer may be [1] deposited over, [2] coated over, or [3] sprayed on the sensing unit. The outer layer may have a thickness which may be less than one of 3 mm, 2 mm, 1 mm, 0.5 mm, and 0.1 mm.

The preset temperature may be determined by [1] the temperature reference system, [2] a user of the temperature reference system, [3] the IR camera, [4] a user of the IR camera, or [5] a user of the assembly.

The assembly may perform [1] maintaining the preset temperature at a constant value. [2] varying the preset temperature according to a preset sequence, [3] varying the preset temperature according to a temperature of the ambient air, [4] varying the preset temperature when the temperature of the target falls between a certain range, or [5] varying the preset temperature when the temperature of the target exceeds a certain value, where the certain value may be greater than 37° C., 37.5° C., 38° C., 38.5° C., 39° C., 39.5° C., or 40° C.

The temperature reference system may include at least two sensing units, and the control unit may maintain the temperatures of the sensing units at two preset temperatures. At least one of the sensing units may be a thermocouple, a thermistor, or a resistance temperature detector. The two preset temperatures may be different from each other or identical to each other. The assembly may perform [1] keeping at least one of such two preset temperatures at a constant value, [2] varying at least one of such two preset temperatures according to a preset sequence, [3] varying at least one of such two preset temperatures according to a temperature of the ambient air, [4] varying at least one of such two preset temperatures when the temperature of the target falls between a certain value, or [5] varying at least one of such two preset temperatures when the temperature of the target exceeds a certain value.

The sensing unit may be mechanically (fixedly or detachably) coupled to the IR camera. The sensing unit may be disposed closer to the target than the IR camera when the IR camera detects the first and second amounts of the IR rays.

In another example, an IR camera assembly may be provided to measure and to calibrate a temperature of a target. The assembly may include a temperature reference system and an IR camera. Such a system may include a temperature reference unit, at least one sensing unit, a control unit, and at least one of a heating unit and a cooling unit. The temperature reference unit may define a top surface which may be exposed to an ambient air and which may have an IR emissivity greater than 0.9 or 0.95. The sensing unit may be disposed in the temperature reference unit and may measure a temperature of the temperature reference unit. At least one of the heating and cooling units may be disposed adjacent to the temperature reference unit, where the heating unit may generate heat, deliver the heat to the temperature reference unit, and increase the temperature of the temperature reference unit, and where the cooling unit may be disposed adjacent to the temperature reference unit, absorb heat from the temperature reference unit, and decrease the temperature of the temperature reference unit. The control unit may maintain the temperature of the temperature reference unit at a preset temperature by manipulating at least one of the heating and cooling units. The IR camera may detect a first amount of first IR rays which are emitted by at least a portion of the top surface of the temperature reference unit and a second amount of second IR rays which are emitted by the target. The assembly may obtain a relationship between the first amount of the IR rays and the temperature of the sensing unit, and may determine a temperature of the target from the second amount of the IR rays using the relationship.

The sensing unit may be disposed [1] on the top surface, where at least a substantial portion of the sensing unit may be exposed to the ambient air, [2] inside a cavity which may be formed in the top surface, where at least a portion but not an entire portion of the sensing unit may be disposed inside the cavity, or [3] inside the cavity in which an entire portion of sensing unit may be disposed.

The preset temperature falls between a low temperature and a high temperature, where the low temperature may be 35° C., 36° C., 37° C., 38° C., or 39° C., where the high temperature may be 37° C., 38° C., 39° C., 40° C., 41° C., or 42° C., and where the low temperature is less than the high temperature.

The sensing unit may be a thermocouple, a thermistor, or a resistance temperature detector. At least one of such heating and cooling units may be a Peltier element.

The preset temperature may be determined by [1] the temperature reference system, [2] a user of the temperature reference system, [3] the IR camera, [4] a user of the IR camera, or [5] a user of the assembly.

The assembly may perform [1] keeping the preset temperature at a constant value, [2] varying the preset temperature according to a preset sequence, [3] varying the preset temperature according to a temperature of the ambient air, [4] varying the preset temperature when the temperature of the target falls between a certain range, or [5] varying the preset temperature when the temperature of the target exceeds a certain value, where the certain value may be greater than 37° C., 37.5° C., 38° C., 38.5° C., 39° C., 39.5° C., or 40° C.

The temperature reference system may include at least two sensing units, and the control unit may maintain the temperatures of the sensing units at two preset temperatures, where such two preset temperatures may be different from each other or identical to each other. At least one of the sensing units may be a thermocouple, a thermistor, or a resistance temperature detector.

The assembly may perform [1] keeping at least one of such preset temperatures at a constant value, [2] varying at least one of such preset temperatures according to a preset sequence, [3] varying at least one of such preset temperatures according to a temperature of the ambient air, [4] varying at least one of such preset temperatures when the temperature of the target may fall between a certain value, [5] varying at least one of such preset temperatures when the temperature of the target may exceed a certain value, or the like.

The sensing unit may either fixedly or detachably couple with the IR camera. The sensing unit may be disposed more proximate to the target than the IR camera when the IR camera may detect the first and second amounts of the IR rays.

In another example, a temperature reference system may provide an IR camera with at least two reference temperatures which the IR camera may use in measuring (and calibrating) a temperature of a target who has an unknown body temperature. The system may include a temperature reference unit, a first sensing unit, a second sensing unit, a control unit, and at least one of a heating unit and a cooling unit. The temperature reference unit may include a first surface, a second surface, and an interior between the first and second surfaces, where the second surface may be exposed to an ambient air and to the IR camera, and where the second surface may define thereon a first pink body and a second pink body each of which may have an IR-ray emissivity which is greater than 0.9. The first sensing unit may be disposed close to the first pink body and measure a first temperature of the first pink body, while the second sensing unit may be disposed close to the second pink body and measure a second temperature of the second pink body, The heating unit or a cooling unit may be disposed close to the first surface, where the heating unit may generate heat, delivers the heat to the first and second pink bodies, and increase temperatures of the first and second pink bodies, and where the cooling unit may absorb heat from the first and second pink bodies, and decrease temperatures of the first and second pink bodies. The control unit may manipulate at least one of the heating and cooling units in order to maintain the first temperature at a first preset temperature and to maintain the second temperature at a second preset temperature. The temperature reference system may generate a first signal and a second signal each representing the first temperature and the second temperature, respectively, and send the first and second signals to the IR camera either wirelessly or through a wire. Therefore, the temperature reference system may allow the IR camera to detect a first amount of IR rays emitted by the first pink body, to detect a second amount of IR rays emitted by the second pink body, to obtain a first relationship between the first amount and the first temperature, to obtain a second relationship between the second amount and the second temperature, to detect a third amount of IR rays emitted by the target, and to determine the temperature of the target using at least one of the first and second relationships.

The first or second sensing unit may be one of a thermocouple, a thermistor, and a resistance temperature detector. The first sensing unit may be disposed [1] on the second surface and right next to the first pink body, [2] on the second surface but (separated) away from the first pink body by a first lateral distance along a lateral direction which is parallel with the second surface, [3] immediately below the first pink body while contacting the first pink body, or [4] between the first and second surfaces and away from the first pink body by a first vertical distance along a vertical direction which is perpendicular to the lateral direction.

At least one of the preset temperatures may be a body temperature of a normal person, a person with a fever, or another person with a hyperthermia. One of the preset temperatures may be a body temperature of a normal person, while another of the preset temperatures may be another body temperature of a person with a fever or another person with a hyperthermia. Alternatively, both of the preset temperatures may be body temperatures of a person with a fever or another person with a hyperthermia.

The system may also include a first outer layer which may sit on top of the first pink body, which may be deposited on, coated over, or sprayed on the first pink body, and which may perform [1] minimizing absorption of one of water and water vapor therein, [2] repelling water therefrom, [3] resisting mechanical scratch, abrasion, or shock, or [4] minimizing reflection of the IR rays therefrom. The first outer layer may have a thickness which is less than 3 mm, 2 mm, 1 mm, 0.5 mm, or 0.1 mm.

The first preset temperature may lie between a first low temperature and a first high temperature, where the first low temperature may be 35° C., 36° C., 37° C., 38° C., or 39° C., where the first high temperature may be 37° C., 38° C., 39° C., 40° C., 41° C., or 42° C., and where the first low temperature is less than the first high temperature. The first preset temperature may be determined by [1] the temperature reference system, [2] a first user of the temperature reference system, [3] the IR camera, [4] a second user of the IR camera, or [5] a third user of the assembly.

The system may perform [1] keeping the first preset temperature at a constant value, [2] varying the first preset temperature according to a preset sequence, [3] varying the first preset temperature according to a temperature of the ambient air, [4] varying the first preset temperature when the temperature of the target falls between a certain range, or [5] varying the first preset temperature when the temperature of the target exceeds a certain value, where the certain value may be greater than 37° C., 37.5° C., 38° C., 38.5° C., 39° C., 39.5° C., or 40° C.

At least one of the heating and cooling units may be a Peltier element.

The temperature reference unit may be fixedly or detachably coupled to the IR camera. The temperature reference unit may be disposed closer to the target than the IR camera when the IR camera detects the first and second amounts of the IR rays.

In another example, a method is provided for measuring a temperature of a target, where the method may include the steps of positioning a sensing unit to face an IR camera; maintaining a temperature of the sensing unit at a preset temperature; measuring a temperature of the sensing unit; detecting a first amount of IR rays emitted by the sensing unit using the IR camera; obtaining a first relationship between the first amount and the measured temperature; detecting a second amount of IR rays emitted by the target; and measuring the temperature of the target based on the second amount as well as the first relationship.

In another example, a method is provided for measuring a temperature of a target, where the method may include the steps of positioning a temperature reference unit to face an IR camera; maintaining a temperature of the temperature reference at a preset temperature; measuring a temperature of at least a certain portion of the temperature reference unit; detecting a first amount of IR rays emitted by the certain portion of the temperature reference unit using the IR camera; obtaining a first relationship between the first amount and the measured temperature; detecting a second amount of IR rays emitted by the target; and measuring the temperature of the target based on the second amount as well as the first relationship.

In another example, a method is provided for providing at least two reference temperatures to an IR camera using a temperature reference system so that the IR camera may use such reference temperatures in measuring (and calibrating) a temperature of a target who has an unknown body temperature. The method may include the steps of providing a temperature reference unit which includes a first surface, a second surface, and an interior between the first and second surfaces; positioning the second surface to be exposed to an ambient air and to the IR camera; defining a first pink body and a second pink body on the second surface each of which has an IR-ray emissivity which is greater than 0.9; installing a first sensing unit close to the first pink body and measures a first temperature of the first pink body; installing a second sensing unit close to the second pink body and measures a second temperature of the second pink body; maintaining a first temperature of the first pink body at a first preset temperature and a second temperature of the second pink body at a second preset temperature, generating a first signal representing the first temperature and a second signal representing the second temperature; and allowing the IR camera (1) to detect a first amount of IR rays emitted by the first pink body, (2) to detect a second amount of IR rays emitted by the second pink body, (3) to obtain a first relationship between the first amount and the first temperature, (4) to obtain a second relationship between the second amount and the second temperature, (5) to detect a third amount of IR rays emitted by the target, and (6) to determine the temperature of the target using at least one of the first and second relationships.

### BRIEF DESCRIPTION OF THE DRAWINGS

FIG. 1 shows an exemplary configuration of a temperature reference system of this disclosure;

FIG. 2 shows an exemplary configuration of a temperature reference unit which includes three temperature reference sub-units each of which is provided as a separate article;

FIG. 3 shows an exemplary configuration of a temperature reference unit which includes three sub-units all of which are provided as a unitary article of a temperature reference system;

FIG. 4 is a schematic view of exemplary locations or positions of the temperature ref. systems or temperature ref. units with respect to the IR camera;

FIG. 5 is one exemplary temperature reference system, where the temperature ref. system is exposed to an IR camera in an upward direction;

FIG. 6 is another exemplary temperature reference system, where an IR camera similarly looks at the temperature ref. unit of the temperature ref. system from the top in the figure;

FIG. 7 is another exemplary temperature reference system, where the heating unit or cooling unit may be incorporated underneath or below the temperature ref. unit of the temperature ref. system;

FIG. 8 is another exemplary temperature reference system, where at least a portion (e.g., an edge) of the temperature reference unit is covered by a body of the temperature ref. system or by other objects;

FIG. 9 is another exemplary temperature reference system, where a sensing unit is placed inside the temperature ref. unit, similar to that (31F) of FIG. 6;

FIG. 10 is another exemplary temperature reference system, where a sensing unit is placed on top of a temperature ref. unit, similar to that (31E) of FIG. 6;

FIG. 11 exemplifies a still image which is captured by an IR camera, where multiple targets who are walking along an isle are captured, and a temperature ref. system fixed onto a ceiling is also captured;

FIG. 12 shows an exemplified embodiment to select a single or multiple pink bodies using a hardware or software of a computer, an image processor or any other image processing equipment each of which is operatively coupled to an IR camera (wirelessly or through wire);

FIGS. 13 and 14 show exemplary temperature reference systems which include the temperature ref. units which in turn include the curved top surfaces;

FIG. 15 is a diagram illustrating an exemplary temperature profile across a temperature reference system, where a heating unit of the system heats the unit and maintains its temperature at a preset temperature and where the Biot number is far less than 1.0;

FIG. 16 is another diagram of the temperature reference system of FIG. 15, where the Biot number is far greater than 1.0;

FIG. 17 is an exemplary temperature reference system which includes a temperature ref. unit and at least one vertical air guard placed around a perimeter of the temperature ref. unit;

FIG. 18 is another exemplary temperature reference system which includes a temperature ref. unit and which also includes at least one vertical air guard and at least one horizontal air guard placed respectively around and over the temperature ref. unit;

FIG. 19 is another exemplary temperature reference system which includes a temperature ref. unit and which also includes at least one air guard enclosing a pink body therein;

FIG. 20 is an exemplary temperature reference system with at least one sensing unit implemented on a top surface of a body of the system;

FIGS. 21 to 23 show exemplary embodiments in which a sensing unit is implemented vary proximate to a temperature ref. unit; and FIG. 24 is an exemplary sensing unit which is capable of serving as a pink body.

### DETAILED DESCRIPTION

Disclosed hereinafter include various exemplary aspects, various embodiments of each aspect, and various examples of each embodiment of various temperature reference systems and their various units, where such temperature ref. systems may provide at least one reference temperature which may be used to automatically or manually calibrate a temperature of a target which is measured by an IR thermal imaging camera.

More particularly, this disclosure relates to various configurational and operational features of such temperature reference systems, and their temperature reference units each of which may include at least one pink body. This disclosure further relates to various methods of constructing or using such temperature ref. systems, their temperature ref. units, and their pink bodies as well as various methods of coupling and using such systems and units with an IR camera.

It is appreciated that this disclosure is provided with reference to accompanying drawings and text, in which the exemplary aspects, embodiments or examples only represent different forms. However, such temperature reference systems and various methods related thereto may also be embodied in different configurations, structures or methods in such a way that they should not be limited to various exemplary aspects and embodiments as set forth in this disclosure. Rather, such exemplary aspects and embodiments described in this disclosure are provided such that this disclosure will be thorough and complete, and fully convey the scope of various temperature ref. systems and methods of using such systems to one of ordinary skill in the relevant art.

Unless otherwise specified, various units, elements or parts of the temperature ref. systems are not typically drawn to proportions or scales in the accompanying figures for ease of illustration. It is also appreciated that such units, elements or parts of such systems as well as their operations and steps designated by the same numerals in the accompanying figures represent the same, similar or functional equivalent systems, units, elements, parts, operations and steps, respectively.

Reference is made to accompanying drawings which show, by way of illustration, various exemplary aspects or embodiments in which various temperature ref. systems may be made and various methods related to such systems may be practiced.

It is noted that numerals appearing between parentheses “(” and “)” such as, e.g., (10) or (60) in this disclosure represent those systems, units, elements or parts which appear in the drawings. It is also noted that parentheses “[” and “]” such as, e.g., [1], [2] or [3] may represent that they are alternatives to each other.

It is also noted that an arrangement or a position of each unit, element or part of various exemplary aspects or embodiments of this disclosure may also be modified to certain extents without departing from the spirits and scopes of other exemplary temperature reference systems of this disclosure.

Therefore, following detailed description is not to be taken to limit the scope of various temperature reference systems for providing at least one reference temperature to the IR camera, not to mention various methods of coupling such systems with the IR camera, computer or other equipment. The scope of such systems and related methods are defined only by appended claims that should be appropriately interpreted in a full range of equivalents to which such claims are entitled. In the drawings, like reference numerals identify like or similar elements or functions through the several views.

Hereinafter, exemplary aspects and embodiments of various temperature reference systems will be explained in detail with reference to the accompanying drawings so that those skilled in the art can easily understand and use such systems, can manufacture such systems, and can perform various operations and steps for such systems, or the like.

The first exemplary aspect of this disclosure relates to an exemplary configuration of a temperature reference system which includes a temperature reference unit and which may optionally include a heating unit, a cooling unit, and a control unit.

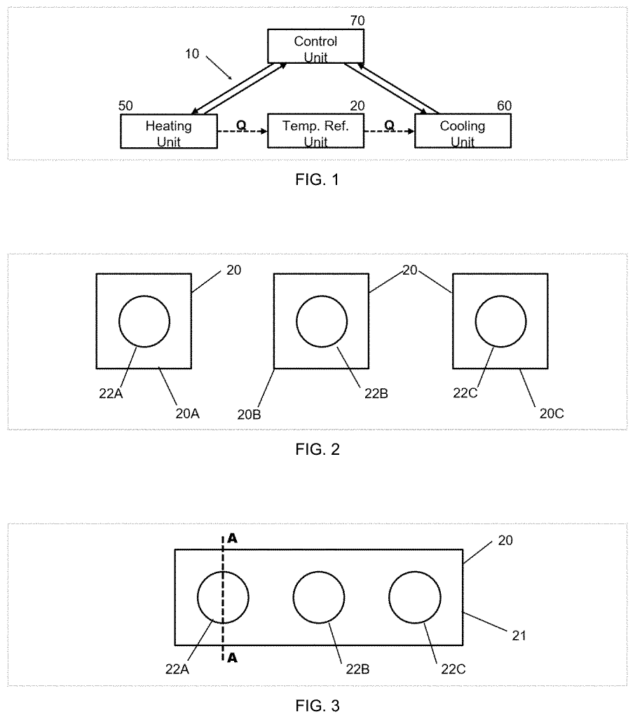

A configuration of an exemplary temperature reference system (10) of this disclosure is depicted in FIG. 1, where a temperature reference system unit (20) may include at least one portion which is to be referred to as a “pink body” hereinafter. A temperature of the pink body of the temperature reference unit (20) may serve as a reference temperature for the IR camera and may be subject to change depending on heat transfer from or to the surrounding environment. To maintain the temperature of the pink body, the typical temperature reference system (10) may also optionally include at least one heating unit, cooling unit, or the like.

For example, a “heating unit (50)” can heat a pink body of the temperature ref. unit (20) and increase the temperature of the pink body. To this end, the heating unit (50) can electrically and directly heat the pink body, e.g., by providing thermal energy to the pink body, by irradiating IR rays to the pink body, by supplying a heating medium (e.g., liquid or gas) to the pink body.

In addition, a “cooling unit (60)” may cool the pink body of the temperature ref. unit (20) and decrease the temperature of the pink body. To this end, the cooling unit (60) may electrically and directly cool the pink body, e.g., by employing a Peltier element or may supply a cooling medium (e.g., liquid or gas) to the pink body.

A “control unit (70)” may control various operations of the heating unit (50) or cooling unit (60). For example, the control unit (70) may employ prior art control algorithms (e.g. various control algorithms for the on-off control, PID control, PI control, PD control, P control, adaptive control, or the like) in order to maintain the temperature of the pink body of the temperature ref. unit (20) at the reference temperature, to minimize an overshoot or a time delay which is inherent in some prior art control algorithms, or the like.

The control unit (70) may maintain a temperature of the pink body of the temperature ref. unit (20) closer to the reference temperature. As discussed above, the reference temperature may be set closer to a body temperature of a human who may be normal, with fever, in hyperthermia, or the like. Therefore, the temperature ref. system (10) may allow the IR camera to automatically or manually calibrate itself. The control unit (70) may also control operations of other units of the temperature ref. system (10) either directly or indirectly through another unit as will be explained below.

Although not shown in FIG. 1, a “temperature sensing unit” (or simply a “sensing unit) may be positioned in a certain location of the temperature ref. system (10). The sensing unit may monitor the temperature at the location, e.g., the location of or adjacent to a pink body of a temperature ref. unit (20). The sensing unit may relay the measured temperature to the control unit (70) which may then turn on or off the heating unit (50) or cooling unit (60) based on the measured temperature, thereby maintaining the temperature of the pink body (or that adjacent to the pink body) and also providing a reliable reference temperature to the IR camera.

A “communication unit” (not shown in FIG. 1) may allow the temperature ref. system (10), its temperature ref. unit (20), or other units to communicate with each other, with the IR camera, with a computer, with a processor, or the like. Such communication may be wireless or through wire.

The temperature ref. system (10) may also include other units in order to [1] more effectively maintain a temperature of a pink body at a desired reference temperature, or within a desired range of the reference temperature, [2] more precisely or quickly control a temperature of a pink body, [3] more effectively communicate with an IR camera, computer or processor, or [4] manage power supply to the temperature ref. system (10), the temperature ref. unit (20) or other units of the system (10).

A temperature ref. system (10) may be constructed in an alternative configuration. For example, a temperature ref. system (10) may not have to include all of the aforementioned units, may not have to include the communication unit, or may not have to include the heating unit (50) or the cooling unit (60).

In particular, the temperature ref. system (10) may not include the heating unit (50) when an ambient temperature is usually above the desired reference temperature or when the cooling unit (60) may also serve as the heating unit (50), e.g., when the cooling unit (60) is a heat exchanger.

Similarly, the temperature ref. system (10) may not have to include the cooling unit (60) when an ambient temperature is usually kept below the desired reference temperature or when the heating unit (50) may also serve as the cooling unit (60), e.g., when the heating unit (50) is a heat exchanger.

A Peltier element may be used both as a heating (50) and cooling unit (60), when the Peltier element may provide heat to the pink body or may take heat away from the pink body.

Configurational features, manufacturing features, use features, their modifications or their variations of the above first exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The second exemplary aspect of this disclosure relates to an exemplary configuration of a temperature reference system which includes a temperature reference unit which in turn includes at least two temperature reference sub-units which may be provided as separate articles.

The temperature ref. system (10) may include a temperature ref. unit (20) which may include multiple temperature reference sub-units each which is to be abbreviated hereinafter as a “temperature ref. sub-unit,” a “temp. ref. sub-unit” or a “sub-unit.”

FIG. 2 is a top view of the above configuration, where a temperature ref. unit (20) may include three temperature ref. sub-units (20A), (20B), (20C) each of which is provided as a separate article, each of which has the same shape and size, each of which is laterally disposed on a temperature ref. unit (20), and each of which may be maintained to have the identical, similar or different reference temperatures.

Each sub-unit (20A)-(20C) may define thereon at least one pink body (22A), (22B), (22C), where a control unit (70) may maintain temperatures of the pink bodies (22A)-(22C) at (or near) the fixed or variable reference temperature, within a certain range of ref. temperature or at different temperatures.

The control unit (70) may control, e.g., the temperature of a 1st pink body (22A) of a 1st sub-unit (20A) at 37° C., the temperatures of a 2^{nd} pink body (22B) of a 2^{nd} sub-unit (22B) at 38° C., of a 3^{rd} pink body (22C) of a 3^{rd} sub-unit (22C) at 39° C., or the like. Therefore, the temperature ref. system (10) including the temperature ref. unit (20) of FIG. 2 can provide the IR camera with three reference temperatures which may be different from each other but which may be in the range of a body temperature of a human who may be normal or who may have a fever or hyperthermia.

The temperature ref. unit (20) may include the temperature ref. sub-units at least two of which may have shapes or sizes different from those of FIG. 2, such that [1] at least two sub-units may have different sizes or shapes, and their pink bodies also have different shapes or sizes, [2] at least two sub-units may have the same shape or size, but their pink bodies may define different shape or size, [3] at least two sub-units may have different sizes or shapes, but their pink bodies may have the same shape or size, or the like. At least two temperature ref. sub-units may also be mechanically connected to each other.

The temperature ref. unit (20) may also include at least two temperature ref. sub-units which may be made of or include various materials such that [1] at least two sub-units or their pink bodies may be made of or include the same material or [2] at least two sub-units or their pink bodies may be made of or include different materials. At least two temperature ref. sub-units may also be mechanically connected to each other.

An IR camera may be positioned on top of the temperature ref. unit so that the IR camera may detect IR rays emitted by the unit. It is noted that an amount of the IR rays which can be detected by the IR camera may decrease as an angle of incidence (or an incident angle) of the IR rays onto the detector deviates from a right angle. Therefore, it is preferred that the temperature ref. unit may be positioned in such an orientation that the unit faces the camera at the right angle. Or a user may position the IR camera such that the detector of the camera may see the unit at the right angle.

When multiple sub-units are provided on the temperature reference unit, it is also preferred that the IR camera may see each sub-unit at the right angle. To this end, each sub-unit may be fabricated to adjust its orientation such that a user may adjust the incident angle of each sub-unit.

Configurational features, manufacturing features, use features, their modifications or their variations of the above second exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The third exemplary aspect of this disclosure also relates to an exemplary configuration of a temperature reference system which includes a temperature reference unit which in turn includes at least two temperature reference sub-units which may be provided as a unitary article.

FIG. 3 is a top view of such a configuration, where a temperature ref. unit (20) includes three sub-units (20A), (20B), 20(C) all of which are provided on a body (21) of the temperature ref. unit (20). Thus, such sub-units (20A)-(20C) provided on the body (21) may be regarded as a unitary article.

Each sub-unit includes at least one pink body (22A), (22B) or (22C) of which temperatures may be controlled by the control unit (70). For example, the control unit (70) may control the temperature of a 1^{st} pink body (22A) of a 1^{st} sub-unit at about 36.5° C., that of a 2^{nd} pink body (22B) of a 2^{nd} sub-unit at about 37° C., that of a 3^{rd} pink body (22C) of a 3^{rd} sub-unit at about 37.5° C., or the like. Alternatively, the control unit (70) may control the temperatures of the pink bodies (22A)-(22C) at about 36.0° C., 36.6° C., and 37.0° C., respectively.

Therefore, the temperature reference system (10) having the temperature ref. unit (20) of FIG. 3 can provide the IR camera with three different ref. temperatures all of which are in the range of a human body temperature. More particularly, such reference temperatures may render an IR camera to detect a person with a normal body temperature more accurately.

The control unit (70) may also control temperatures of the sub-units (20A)-(20C) or their pink bodies (22A)-(22C) of FIG. 3 at different values or within different ranges. For example, the control unit (70) may control the temperature of a 1^{st} pink body (22A) of a 1^{st} sub-unit at 38.0° C., that of a 2^{nd} pink body (22B) of a 2^{nd} sub-unit at 38.5° C., that if a 3^{rd} pink body (22C) of a 3^{rd} sub-unit at 39° C., or the like, where such reference temperatures may render an IR camera to detect a person with a fever or hyperthermia.

Therefore, the temperature ref. system (10) may provide an IR camera with at least one reference temperature which may fall with a range of a body temperature of a normal person or of a person with a fever or hyperthermia. Thus, the IR camera may detect a normal person or a person who have a fever or who suffer from hyperthermia more accurately.

The temperature ref. unit (20) may include the temperature ref. sub-units at least two of which may have shapes or sizes different from those of FIG. 3, such that [1] at least two sub-units may have different sizes or shapes, and their pink bodies also have different shapes or sizes, [2] at least two sub-units may have the same shape or size, but their pink bodies may define different shape or size, or [3] at least two sub-units may have different sizes or shapes, but their pink bodies may have the same shape or size.

The temperature ref. unit (20) may include the temperature ref. sub-units which may be made of or include various materials. For example, at least two sub-units or their pink bodies may be made of or include the same material or at least two sub-units or their pink bodies may be made of or include different materials.

Regardless of the shapes, sizes or materials, the control unit may manipulate the pink bodies at the same temperature or different temperatures. Alternatively, the control unit may manipulate the pink bodies to have different temperatures depending upon their shapes, sizes or materials.

At least two temperature ref. sub-units may be mechanically fixed onto the body (21) of the temperature ref. unit (20) so that their positions do not change. Alternatively, at least one sub-unit may be movably coupled to the body (21) such that Its position with respect to another sub-unit and/or its height above the body (21) or its depth below the body (21) may be variably adjusted.

Configurational features, manufacturing features, use features, their modifications or their variations of the above third exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The fourth exemplary aspect of this disclosure relates to an exemplary configuration of incorporating or positioning a temperature reference system and at least one temperature reference unit.

The temperature ref. systems and their temperature ref. units may be positioned in various locations depending upon [1] a structure in which the temperature ref. systems or IR cameras are installed, [2] an environment in which such systems or IR cameras are to be installed, [3] a position of a target, [4] a path of a target when the target is moving, [5] an orientation between the IR cameras and the pink bodies which provide the IR cameras with the reference temperatures, or the like.

The temperature ref. systems and their temperature ref. units may be positioned in various locations while further taking account of [1] a distance to the target (or IR camera), [2] an orientation of the target (or IR camera), [3] a number of target (i.e., whether measuring temperature of a single target or those of multiple targets), [4] a horizontal angle with respect to a target (or an IR camera), [5] a vertical angle with respect to the target (or an IR camera), [6] a temperature of an ambient air, [7] a presence or absence of a flow of an ambient air, [8] a magnitude and a direction of the ambient air flow, or the like.

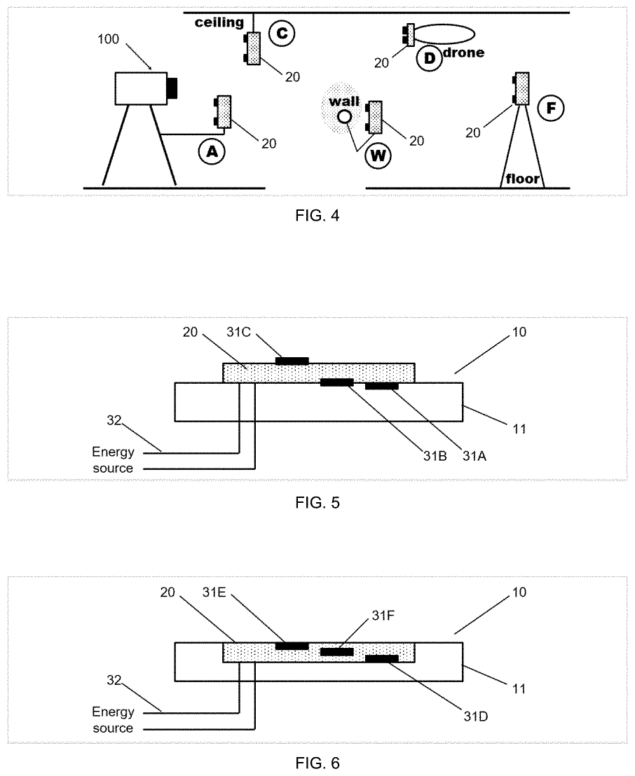

FIG. 4 is a schematic view of exemplary locations, positions or orientations of a temperature ref. system or a temperature ref. unit with respect to a IR camera (including a computer or a processor). As shown in FIG. 4, the temperature ref. system (10) may be positioned while mechanically coupling with an IR camera (100) or while being separated therefrom.

For example and as to the position (A) in FIG. 4, a temperature ref. system (10) may be releasably or fixedly coupled to an IR camera (100), where its temperature ref. unit may be oriented to face the IR camera (100). Thus, the temperature ref. system (10) and IR camera (100) may be fabricated as a unitary article. This assembly offers the benefit of easily installing or moving the temperature ref. system (10) with the IR camera.

The temperature ref. unit (20) may be movably or releasably coupled to an IR camera (100) so that a distance, an angle or an orientation between the temperature ref. unit (20) and the IR camera (100) may be adjustable by a user. In this configuration, a user may also easily adjust a distance, an angle or an orientation between the temperature ref. unit (20) and a target.

The IR camera (100) can measure a temperature of a target (a person walking along, e.g., from the right to the left of FIG. 4) when the target is still farther away from the IR camera (100) (e.g., a far-right side of FIG. 4), e.g., as the target approaches the IR camera (100) (e.g., in the middle portion of FIG. 4) or as the target passes by the IR camera (100).

As to the position (F) in FIG. 4, the temperature ref. system (10) may be placed on the floor. Thus, the temperature ref. system (10) and IR camera (100) are physically placed apart from each other. A distance to the IR camera (100), an angle with respect to the IR camera (100), or an orientation to the IR camera (100) may be adjustable by a user. This assembly offers the benefit that the temperature ref. system (10) may be movably or fixedly (with respect to a floor) placed at a preferable distance, orientation, angle, or the like, with respect to the IR camera (100) (or a target).

The IR camera (100) can measure a temperature of a target when the target is still farther away from the IR camera (100) (e.g., a far-right side of FIG. 4, or near the temperature ref.

system (10)), e.g., as the target approaches the IR camera (100) (as depicted in the middle portion of FIG. 4 or between the IR camera (100) and the temperature ref. system) (10) or as the target passes by the IR camera (100). The IR camera (100) may monitor a person when the person passes by the temperature ref. system (10) as well.

In general, a flow of an ambient air around or across the pink body of the temperature ref. unit (20) may cause perturbations in the temperature on the oink body, thus causing an error in the reference temperature provided to the IR camera. In addition, an air flow around or across a target may cause perturbations in the temperature on a skin of the target, thus causing an error in the temperature measured by the IR camera.

Such errors may be mitigated or prevented by positioning the pink body of the temperature ref. unit (20) in a place where the air flows are minimal. In addition, by positioning the temperature ref. system (10) near a target, the IR camera can effectively reduce the error.

As to the position (C) in FIG. 4, the temperature ref. system (10) may be put on or below a ceiling of a structure. Detailed installation and characteristics of this positioning are identical or similar to those of the exemplary position (F). As to the position (W) in FIG. 4, the temperature ref. system (10) is placed on a wall of the structure. Detailed installation and characteristics of such a positioning are identical or similar to those of the exemplary position (F).

As to the position (D) in FIG. 4, the temperature ref. system (10) may move or may be carried by a moving object which moves vertically, horizontally or angularly along a track which may be provided on a 2-D plane or in a 3-D space and which may be provided on a floor, on a ceiling, on a wall, away from the floor, ceiling or wall, or the like.

The temperature ref. system (10) may be fabricated such that the system (10) may be incorporated into, or carried by [1] a robot moving on a floor, [2] a flying object such as, e.g., a miniature plane, a small chopper, or a drone, or [3] other objects which can move and thus change its position. As a result, the temperature ref. system (10) may be fabricated as a mobile system which can change a position, a distance, an angle or an orientation with respect to the IR camera (100) or the target.

In such a configuration, a position, a speed, a vector velocity or a curvilinear path of the movement of the temperature ref. system (10) may be pre-selected by or may be dynamically manipulated by [1] the temperature ref. unit (20), [2] the control unit (70) of the system (10), [3] the IR camera (100), [4] a user of the temperature ref. system (10), or [5] a user of the IR camera (100).

When desirable, the moving object may not move the entire temperature ref. system (10). Rather, when the pink body or at least a portion of the temperature ref. unit (20) may be provided physically detachable from the rest of the temperature ref. system (10) and may communicate with the rest of the system (10), the moving object may only move the pink body of that portion of the temperature ref. unit (20).

The moving object may move along with not the temperature ref. system (10) but at least a portion of the IR camera (100). Or the moving object may move not only the IR camera (100) but the pink body or at least a portion of the temperature ref. unit (20).

Configurational features, manufacturing features, use features, their modifications or their variations of the above fourth exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The fifth exemplary aspect of this disclosure relates to an exemplary configuration of a temperature reference unit and its pink body and to various methods of making and using such a system and pink body.

Various temperature reference units of this disclosure may define various pink bodies on its surface. Following FIGS. 5 to 10 describe various exemplary temperature reference systems, and their temperature reference units as well as their pink bodies, in conjunction with various temperature sensing units (to be referred to as a “sensing unit” hereinafter).

It is noted that FIGS. 5 to 10 exemplify the temperature ref. systems which include heating units and may heat their temperature ref. units in order to maintain the temperature of such temperature ref. units (or their pink bodies) at a desired reference temperature. Although not explained in conjunction with those figures, the temperature ref. systems may include a cooling unit and cool their temperature ref. units, e.g., by providing a liquid or gas coolant to such units, by implementing a Peltier element thereat, by installing a fan and provide ambient air as a coolant, or the like.

FIG. 5 is a cross-section of an exemplary temperature reference system (10), where a user installs the system (10) in such a way that the temperature ref. system (10) is exposed to an IR camera in an upward direction when installed, i.e., an IR camera looks at the temperature ref. unit (20) of the system (10) from the top in the figure. The temperature ref. unit (20) may be provided on a top surface of a body (11) of the temperature reference system (10).

The temperature ref. system (10) may include at least one energy source (32) such as, e.g., a battery or a DC/AC power supply, which provides various units of the temperature ref. unit (20) with electric energy. The temperature ref. unit (20) may then be heated due to its electrical resistance, and its temperature increases to a preset reference temperature via a control action by the control unit (70).

In one example, a sensing unit may be installed in a preset position of a temperature ref. unit (20) and measure a temperature of the temperature ref. unit (20) (or its pink body). In another example, a sensing unit (31A) may be placed on a top surface of the body (11), may be placed to be flush with the top surface of the body (11), e.g., in a groove that is formed on a top surface of the body (11), or the like. The sensing unit (31A) may also contact the bottom of the temperature ref. unit (20) in order to measure a temperature of the temperature ref. unit (20).

In another example, a sensing unit (31B) may be placed between the temperature ref. unit (20) and the body (11). For this placement, the sensing unit (31B) may be formed as a flat article, and then placed, e.g., between a bottom surface of the temperature ref. unit (20) a top surface of the body (11). Instead, the sensing unit (31B) may be placed in a groove formed in both of the body (11) and the temperature ref. unit (20).

In another example, a sensing unit (31C) may be placed on a top surface of the temperature ref. unit (20). Or the sensing unit (31C) may sit on a top surface of the body (11). As a result, the sensing unit (31C) is exposed to an ambient air. The sensing unit (31A) may be glued to or otherwise couple with the top surface of the temperature ref. unit (20).

As manifest in FIG. 5, incorporating such sensing units (31A)-(31C) may provide different readings of the temperature of the temperature ref. unit (20). Temperature readings of the sensing unit (31A) may be affected by the temperature of the body (11). Temperature readings of the sensing unit (31B) may be less influenced by the temperature of the body (11) compared with the sensing unit (31A). Temperature readings of the sensing unit (31C) may be severely affected by the temperature of the ambient air, by the flow of the ambient air, or the like.

Thus, when the ambient air temperature is over (or below) the ref. temperature, the temperature reading by a sensing unit (31C) can be higher (or lower) than the readings by other sensing units (31A), (31B). But this reading may reflect the temperature of a skin of a target exposed to the same condition. In view of such, the temperature ref. systems (10) may be calibrated while considering the conductive or convective heat transfer effects, or the like. Detailed configurations and methods for preventing or minimizing such measurement errors are to be provided in greater detail in the following eighth exemplary aspect of this disclosure.

FIG. 6 shows a cross-section of another exemplary temperature reference system (10), where an IR camera similarly looks at the temperature ref. unit (20) of the system (10) from the top of the figure. A temperature ref. unit (20) may receive energy from an energy source (32) and, accordingly, its temperature may increase to the reference temperature, or may rather lose energy to an energy source (32) and, therefore, its temperature may decrease down to the preset reference temperature. Further details are similar to those of FIG. 5 and, omitted herein.

Various sensing units may be incorporated into various positions to measure a temperature of the temperature ref. unit (20) or its pink body. In one example, a sensing unit (31D) may be placed on a bottom surface of the temperature ref. unit (20). The sensing unit (31D) may be placed to be flush with a bottom surface of the temperature ref. unit (20), e.g., in a groove formed on that bottom surface. The sensing unit (31D) may contact a top surface of a body (11) of the temperature ref. system (10).

In another example, a sensing unit (31E) may be placed on a top surface of the temperature ref. unit (20). A sensing unit (31E) may be implemented to be flush with a top surface of the unit (20), e.g., inside a groove formed on that top surface. Thus, the sensing unit (31C) is exposed to an ambient air. Because the sensing unit (31E) is placed inside the groove, the effects from the ambient air may be less than the case of the sensing unit (31C).

In another example, a sensing unit (31F) may be placed inside the temperature ref. unit (20). The sensing unit (31F) may be inserted inside a pre-formed cavity of the temperature ref. unit (20). In the alternative, during the fabrication of the temperature ref. unit (20), the sensing unit (31F) may be implemented into the temperature ref. unit (20).

As manifest in FIG. 6, incorporating such sensing units (31D)-(31F) may provide different readings of the temperature of the temperature ref. unit (20).

For example, temperature readings of the sensing unit (31D) may be affected by the temperature of the body (11). Temperature readings of the sensing unit (31E) may be affected by a temperature of an ambient air, by the flow of the ambient air towards or away from the sensing unit (31E), or the like, as explained with the sensing unit (31C). Furthermore, temperature readings of the sensing unit (31F) may be less influenced by the temperature of the body (11) compared with the sensing unit (31D) or by the ambient air.

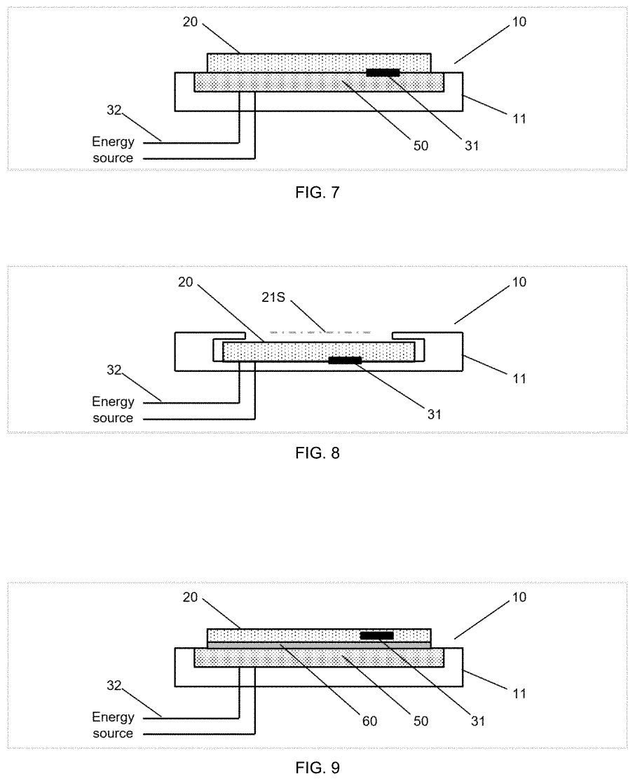

FIG. 7 is a cross-section of another exemplary temperature reference system (10), where the heating unit (50) or cooling unit (60) may be incorporated underneath or below the temperature ref. unit (20) of the temperature ref. system (10). Similar to that of FIGS. 5 and 6, an IR camera of FIG. 7 also looks at the temperature ref. unit (20) of the temperature ref. system (10) from the top.

The system (10) may include an energy source (32) to supply the electric energy to a heating unit (50). Heat may be transferred to the temperature ref. unit (20), thereby increasing its temperature to a preset temperature, e.g., via a control action by the control unit (70).

The energy source (32) may also supply the electric energy to a cooling unit (60. Then, the temperature ref. unit (20) loses its energy and its temperature may decrease to the reference temperature, e.g., similarly via the control action. The heating or cooling unit (50), (60) may instead use a heating or cooling fluid or air as well.

A sensing unit (31) may be placed between the temperature ref. unit (20) and the heating or cooling unit (50), (60). The sensing unit (31) may instead be placed at another location exemplified in FIGS. 5 and 6 or at a different location which is adjacent, over or below such locations in FIGS. 5 and 7. In addition, the temperature ref. system (10) may also employ multiple sensing units (31) as it sees fit.

When the temperature ref. system (10) includes multiple sensing units (31), the system (10) may get an average of multiple temperature readings, e.g., arithmetic, geometric or weighted average, and then use the average as the temperature of the temperature ref. unit (20). Alternatively, the system (10) may discard some unreliable or outlying temperature readings obtained by some sensing units when, e.g., such readings are farther off from the rest of the readings.

Comparing the temperature ref. unit of FIG. 7 with those of FIGS. 5 and 6 where the units (20) may directly heat or cool themselves, the temperature ref. system (10) in FIG. 7 may change its temperature depending upon an amount of heat transferred thereto by a heating unit (50) or the amount of heat dissipated into a cooling unit (60). That is, it is the indirect heating or cooling.

A heating unit (50) or a cooling unit (60) may be incorporated under or beside the temperature ref. unit (20). For example, the temperature ref. unit (20) does not directly have to be heated or cooled so that the temperature of the temperature ref. unit (20) may be maintained at or near the preset reference temperature. Rather, the heating or cooling unit (50), (60) can control the temperature of the temperature ref. unit (20) at or near the reference temperature. Thus, a user may easily select the material of the temperature ref. unit (20), e.g., regardless of the electrical resistance of a temperature ref. unit (20), the thermal conductive thereof, or the like.

A user may make the temperature ref. unit (20) with a material which can resist mechanical scratch, or the like. A heating unit (50) or a cooling unit (60) may have a length (e.g., that measured along a horizontal direction in FIG. 7) which may be greater or less than that of the temperature ref. unit (20).

Other factors may be considered in positioning a heating or cooling unit (50), (60) under or beside a temperature ref. unit (20). For example, an overall thickness (e.g., that measured in a vertical direction in FIG. 7) of a temperature ref. unit (20) may increase. But a total cost may not change, for the heating or cooling unit (50), (60) is already a part of the temperature ref. system (10).

FIG. 8 is a cross-section of another exemplary temperature reference system (10), where at least a portion (e.g., an edge) of the temperature ref. unit (20) is covered by a body (11) of the temperature ref. system (10) or by other objects.

Similar to that of FIGS. 5 to 7, an IR camera looks at the temperature ref. unit (20) of the temperature ref. system (10) of FIG. 8 from the top. For example, edges of a top surface of the body (11) extrudes inwardly, thereby covering edges of the temperature ref. unit (20). As a result, not an entire portion of the top surface of the temperature ref. unit (20) may be exposed to the IR camera. Due to a partial encapsulation, the temperature ref. unit (20) can also be mechanically supported by the body (11).

It is noted that the temperature reference unit (20) may include an additional layer (21S) on its top portion. For example, the top layer (21S) may serve to protect the temperature ref. unit (20) from mechanical impact or abrasion, to decrease resistance to heat transfer into or away from the temperature ref. unit (20), and so on. The desirable thickness of the top layer (21S) are provided below.

An energy source (32) of FIG. 8 may be similar or identical to those sources illustrated in FIGS. 5 and 7 and, therefore, further details are omitted. A sensing unit (31) of FIG. 8 may be similar or identical to those illustrated in FIGS. 5 to 8 and, therefore, further details are omitted.

FIG. 9 is a cross-section of another exemplary temperature ref. system (10), where a sensing unit (31F) may be immersed or placed inside the temperature ref. unit (20), similar to that (31F) of FIG. 6. Thus, the sensing unit (31F) may be inserted inside a pre-formed cavity of the temperature ref. unit (20). Alternatively, during the fabrication, the sensing unit (31F) may be implemented into the temperature ref. unit (20).

The system (10) of FIG. 9 includes not only a heating unit (50) but also a cooling unit (60). It is noted in the figure that the cooling unit (60) is disposed over the heating unit (50). This configuration may be beneficial in the case that the cooling unit (60) may operate more frequently than the heating unit (50). However, the heating unit (50) may be disposed over the cooling unit (60) as well.

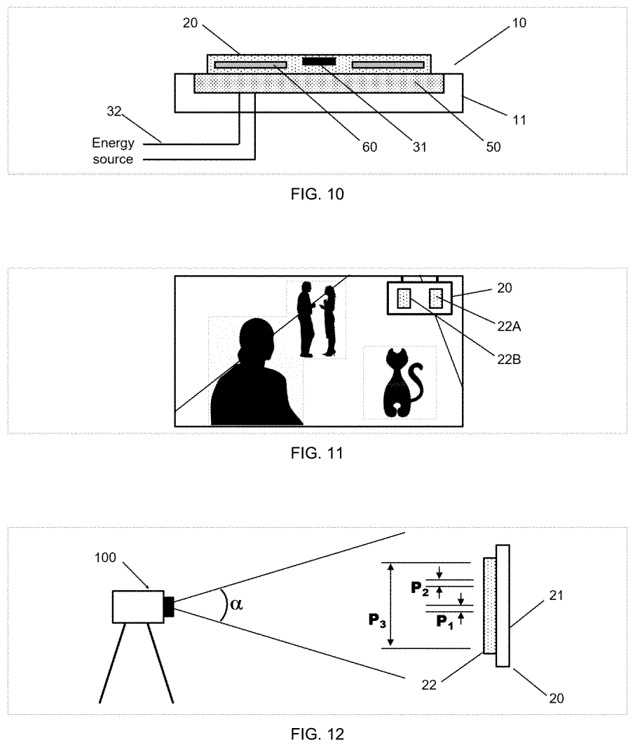

FIG. 10 is a cross-section of another exemplary temperature reference system (10), where a sensing unit (31F) may be placed on top of a temperature ref. unit (20), similar to that (31E) of FIG. 6. Therefore, the sensing unit (31F) may be implemented to be flush with a top surface of such a unit (20), e.g., inside a groove formed on that top surface. As a result, the sensing unit (31C) is exposed to an ambient air. Because the sensing unit (31E) is put inside the groove, the effects from the ambient air may be less than the case of the sensing unit (31C) of FIG. 5.

The temperature ref. system (10) may include a heating unit (50) and a cooling unit (60), where the cooling unit (60) is disposed over the heating unit (50). This configuration may be beneficial where the cooling unit (60) may operate more frequently than the heating unit (50). However, the heating unit (50) may be disposed over the cooling unit (60) as well.

It is appreciated that the temperature ref. system (10) may include a single cooling unit (60) which has a configuration of a circular or oval ring. In this configuration, two rectangles in FIG. 10 correspond to the left and right side of the cooling unit (60). Alternatively, the system (10) may include multiple cooling units (60) which may be disposed on the left and right sides of the body (11) of the system (10).

Configurational features, manufacturing features, use features, their modifications or their variations of the above fifth exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The sixth exemplary aspect of this disclosure relates to an exemplary configuration of a pink body of a temperature reference unit and various methods of making, incorporating, and using the pink body.

As defined above, a “pink body” represents a certain portion of a temperature ref. unit (20) of which temperature is measured and used as a reference temperature by an IR camera. It is appreciated in exemplary configurations in FIGS. 5 to 10 that the pink body may correspond to the entire portion of a top surface of the temperature ref. unit (20) or to only a portion of the top surface thereof.

An IR camera may use the measured temperature of the pink body as a reference temperature when it measures a temperature of a target. That is, the pink body may generally correspond to at least a portion of a top surface of the temperature ref. unit (20) (also referred to as a second surface of the temperature ref. unit (20) or a second interface) which can be seen by an IR camera.

It is noted that an IR camera may not necessarily use a temperature of an entire portion of the top surface when measuring the reference temperature of the temperature ref. unit (20). It is also noted that the IR camera may not necessarily use a temperature of an entire portion of the pink body when measuring the reference temperature of the temperature ref. unit (20).

The largest pink body of a temperature ref. system (10) may amount to an entire portion of the top surface of the temperature ref. unit (20) which can be seen by an IR camera such that, e.g., the IR camera may measure a temperature of the entire portion of the top surface and select the average temperature of the top surface as the reference temperature.

Alternatively, the IR camera may measure a temperature of the entire or only a portion of the top surface and then select a temperature of a specific portion of the top surface as the reference temperature. In this case, the IR camera may always select the specific portion or may automatically or adaptively select a portion based on various algorithms.

In contrary, the smallest pink body of a temperature ref. system (10) may correspond to an area of a top surface of the temperature ref. unit (20) which may correspond to a single pixel of an IR camera such that, e.g., whichever portion of the temperature ref. unit (20) the IR camera may see. Such an IR camera may only pick a very small portion of such a top surface, where the exact size of the pink body may depend upon the number of pixels of the IR camera.

As to the pink bodies of the temperature ref. units (20) in FIGS. 5 to 10, the IR camera may see the entire portion of the top surface of the temperature ref. units (20). As a result, the pink body of each temperature ref. unit (20) may correspond to their entire top surface of such units (20). An IR camera may then look at the entire top surface of the unit (20), and obtain the reference temperature, e.g., from the average temperature of such an entire portion of the temperature ref. unit (20).

As to the pink body of the temperature ref. unit (20) in FIG. 8, an IR camera may only see the portion of the top surface of the temperature ref. units (20) which may be exposed to the camera. Therefore, the pink body of the temperature ref. unit (20) may correspond only to an exposed portion of the top surface of the temperature ref. unit (20). It is noted that the exact area of a pink body may be decided not only by a physical configuration of such temperature ref. units (20) but also by an IR camera.

As will be explained in detail below, the software or hardware of an IR camera (or a computer or a processor coupled therewith) may choose to pick only a portion of a top surface of a temperature ref. unit (20) as the pink body, where the IR camera, computer or processor is collectively referred to as the IR camera. In this aspect, the top surface of the temperature ref. unit (20) may correspond to the maximum area of the pink body, while the actual area of the pink body may depend on how many pixels an IR camera may use in determining the reference temperature.

In order to explain the selection of such pink bodies, FIG. 11 exemplifies a still image which may be captured by an IR camera, where multiple targets who are walking along an isle are captured, and where a temperature ref. system (20) which is fixed onto a ceiling is also captured.

An IR camera may identify a temperature ref. unit (20) from a captured image using various methods. For example, the temperature ref. unit (20) or its sub-units (22A), (22B) may be placed in predetermined positions, and the IR camera may search those positions, thereby identifying the temperature ref. sub-units (22A), (22B) from the image. Or the IR camera may identify the temperature ref. unit (20) which is placed in a preset location or which may emit a beacon signal to the IR camera.

Alternatively, hardware or software of an IR camera, a computer or an image processor coupling to the IR camera may identify the temperature ref. sub-units (22A), (22B) from the image using, e.g., prior art computer vision technology, AI software or the like. Or a user of the IR camera, computer or image processor may manually identify the temperature ref. sub-units (22A), (22B) from the image and then notify the IR camera, computer or image processor of their locations.

The IR camera may select a single pink body or multiple pink bodies using various methods as well. For example, after capturing the image of FIG. 11, an IR camera may identify the temperature ref. sub-units (22A), (22B) of the temperature ref. unit (20).

The IR camera may [1] select the entire portion of each temperature ref. unit (22A), (22B) as the pink bodies, [2] select a preset portion of each temperature ref. unit (22A), (22B) as the pink bodies, [3] select an entire or preset portion of only one temperature ref. unit (22A), (22B) as the pink body or [4] select only a portion of only one of such temperature ref. units (22A), (22B) as the pink body.

Whether the temperature ref. system (10) may include a single or multiple temperature ref. units (20) or whether a temperature ref. unit (20) may include one or multiple temperature ref. sub-units therein, the IR camera may [1] select multiple pink bodies from a single or multiple temperature ref. units or [2] select a single pink body from a single or multiple temperature ref. units.

Instead, the temperature ref. system (10) may select a single or multiple pink bodies from at least one temperature ref. unit adaptively, depending upon, e.g., [1] quality of images of such pink bodies which are captured by an IR camera, [2] a variation in temperatures measured in different portions of a captured image of a target, [3] a temperature, a humidity or a weather of an ambient environment, [4] a temperature of a target which may exceed a certain threshold temperature, [5] receiving a user command, or the like.

In addition, a manufacturer may fabricate multiple pink bodies on at least one temperature ref. unit so that an IR camera or its user may be able to pick and select at least one pink body, to measure a temperature of at least one pink body, and then to measure the temperature as a reference temperature. Even when the manufacturer may fabricate a single pink body, an IR camera or a user may define multiple pink bodies on a captured image and obtain the reference temperature as well.

FIG. 12 shows an exemplary embodiment to select a single or multiple pink bodies using a hardware or software of an IR camera or using a computer, an image processor or any other image processing equipment each of which may operatively couple with an IR camera wirelessly or through wire and, therefore, each of which may receive captured images from the IR camera.

As described above, a computer, a processor or any equipment which may be receive a captured image of a target is collectively referred to as an “IR camera.” However and as illustrated in FIG. 12, when such a computer, processor or equipment is provided as a separate article from the IR camera, they are to be referred to as a “computer” or as a “processor” hereinafter.

As an IR camera captures a target image, the IR camera or the processor may select at least one pink body. Whether or not an IR camera may have already selected any pink body, the processor may receive the captured target image from the IR camera and select a pink body from the images anyway.

As a result, when desirable, the number of the pink body as well as its location on the top surface of the temperature ref. unit as selected or detected by the IR camera may be different from the number or location of the pink body as selected or detected by the processor.

For example, when an IR camera may capture an image, may select a pink body or multiple bodies, and may transmit the image or information as to the pink body to the processor, the processor may select its pink body by, e.g., [1] adopting the same pink body which have been selected by the IR camera, [2] selecting a new pink body which may be wider (or narrower) or taller (or shorter) than the one that has been selected by the camera, or [3] selecting a new pink body of which the shape, size or location may be different from (or similar to) the one that has been selected by the IR camera; or the like.

A temperature ref. system (10) of FIG. 12 may include a single temperature ref. unit (20). An IR camera may have a view angle (a) so that an image captured by the IR camera may include therein (or may see therewith) an entire portion of a top surface of the temperature ref. unit (20).

After receiving the captured image from the IR camera, a processor may then select a pink body as [1] an entire portion of a top surface of a temperature ref. unit (20) (e.g., depicted as P₃ in FIG. 12). [2] not an entire but only portion of a top surface of a temperature ref. unit (20) (e.g., depicted as P₁ or P₂ in FIG. 12), or [3] multiple portions of a top surface of a temperature ref. unit (20) (e.g., those as P₁ and P₂ in FIG. 12).

An IR camera or processor may also select a pink body as a portion of a face or other body parts of a human target while the target stands in a preset position (and in a preset distance), or by recognizing the target in the image and then select the pink body.

Of course, the case of the preceding paragraph may corresponds to a case where the IR camera or processor may know the temperature of the target. The IR camera or processor may then use this temperature as a reference temperature, and measure a temperature of a second target while using the above reference temperature.

The pink body may be incorporated to be fixed or mobile in space. For example, an IR camera or a processor may identify the pink body which is fixed in space (i.e., implemented into a certain location). Thus pink body may not change its position in space and, therefore, immobile. This generally corresponds to a case when the temperature ref. unit is not moving with respect to the IR camera.

Rather, an IR camera or a processor may identify a pink body that may change its position in space. This generally corresponds to a case when the temperature ref. unit is moving with respect to the IR camera. Such a temperature ref. unit (20) may move along a known path or move randomly. The IR camera or processor may use a prior art computer vision technology, AI software or the like in order to track the position of the mobile temperature ref. unit. Or the temperature ref. unit may transmit a beacon signal with which an IR camera or a processor may readily identify the position of the temperature ref. unit and its pink body.

Whether the temperature ref. unit may be mobile or immobile, an IR camera or processor may select one or multiple portions of the mobile or immobile temperature ref. unit as one or multiple pink bodies and, as a result, the pink body may seem to be fixed in space or to move its position.

The above examples explained in conjunction with FIG. 12 may equally apply to a case when [1] the IR camera or a processor may identify multiple pink bodies from a single or multiple temperature ref. units or [2] the IR camera or a processor may identify a single pink body from a single or multiple temperature ref. units.

Configurational features, manufacturing features, use features, their modifications or their variations of the above sixth exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The seventh exemplary aspect of this disclosure relates to further exemplary configurations of a pink body of a temperature reference unit and various methods of making and using the pink body.

In the above exemplary aspects and their embodiments, the temperature ref. units (20) tend to have flat top surfaces. Accordingly, the pink bodies of such temperature ref. units (20) may tend to be flat, where the pink bodies correspond to one or more portions of the top surface of the temperature ref. unit (20) from which the IR camera measures and obtains a reference temperature.

However, a top surface of a temperature ref. unit (20) does not have to be always flat. Rather, at least a portion of the top surface of the unit (20) may be curved and, therefore, a pink body which corresponds to an entire portion or only a portion of the top surface may also be curved.

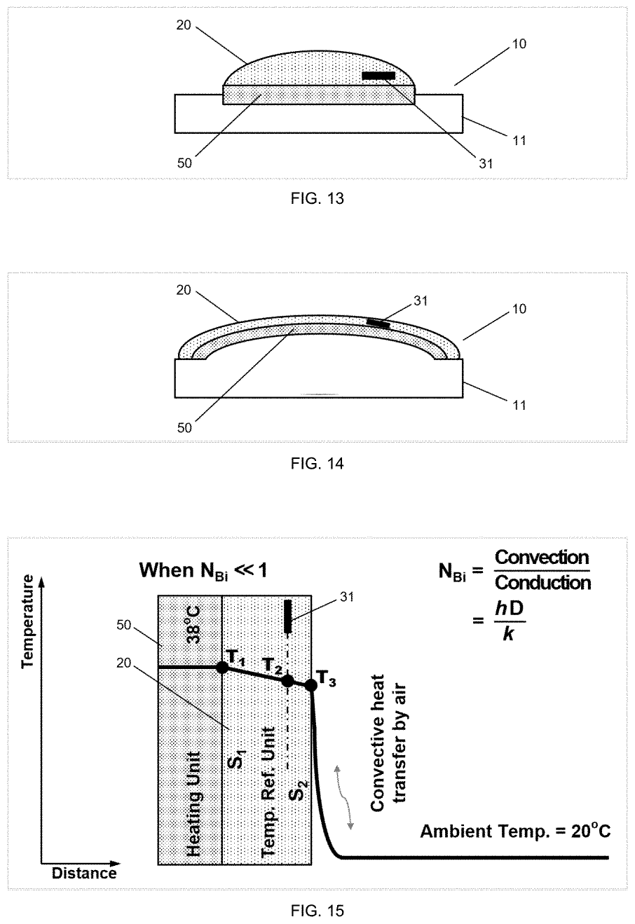

FIG. 13 is a cross-section of an exemplary temperature reference system (10) including a temperature ref. unit (20) which in turn includes a curved top surface. In this example, the temperature ref. unit (20) with a curved top surface sits on top of a heating unit (50) which in turn sits on top of a body (11) of the system (10).

In this configuration, a sensing unit (31) sits inside the temperature ref. unit (20). But the sensing unit (31) may be incorporated to be flush with the top surface (therefore exposed to an ambient air) or may be embedded in an interface between the temperature ref. unit (20) and the heating unit (50).

FIG. 14 is a cross-section of another exemplary temperature reference system (10) which includes a temperature ref. unit (20) which in turn includes a curved top surface. In this example, the temperature ref. unit (20) with a curved top surface sits on top of a heating unit (50) which may also be fabricated to have a curved surface.

The curved top surface of the temperature ref. unit (20) may provide advantages when the IR camera measures the reference temperature therefrom. When the IR camera sees the pink body and receive the IR rays or photons therefrom, an amount of such IR rays may depend on an angle of incidence (or an incident angle).

When the top surface of the temperature ref. unit is flat and the IR camera sees the top surface at an incident angle of 90°, a detector of the IR camera may receive the largest amount of the IR rays. However, when the IR camera sees the top surface at an angle (i.e., the incident angle is not 90°), the detect of the IR camera may receive a less amount of the IR rays and, therefore, may underestimate the reference temperature.

However, when the top surface of the temperature ref. unit is curved, it becomes easier to align the top surface of the temperature ref. unit to be perpendicular to the detector of the IR camera. Therefore, it may be easier to prevent or at least minimize the error caused by the non-perpendicular alignment between the top surface of the temperature ref. unit and the IR camera.

It is noted that the top surface of the temperature ref. unit (20) may have a curvature which is concave downward as exemplified in FIGS. 13 and 14 or which may be concave upward as well. In addition, the curvature may follow that of a sphere, ellipsoid, or the like.

Configurational features, manufacturing features, use features, their modifications or their variations of the above seventh exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The eighth exemplary aspect of this disclosure relates to various methods for accounting for complicated heat transfer into, across, and away from a pink body of a temperature ref. unit, and various methods of more accurately assessing a temperature of a pink body or that of a temperature ref. unit while accounting for such heat transfer.

As will be explained below, this exemplary aspect focuses on identifying inherent errors in measuring a temperature of a pink body of a temperature ref. unit caused by thermal conduction and convection. This exemplary aspect also provides various configurations and methods of improving an accuracy of measuring a temperature of a pink body by compensating for such inherent errors. Thus, an IR camera may more accurately measure a temperature of a pink body and may use it as a reference temperature in calibrating the temperature of a target which is measured by the IR camera.

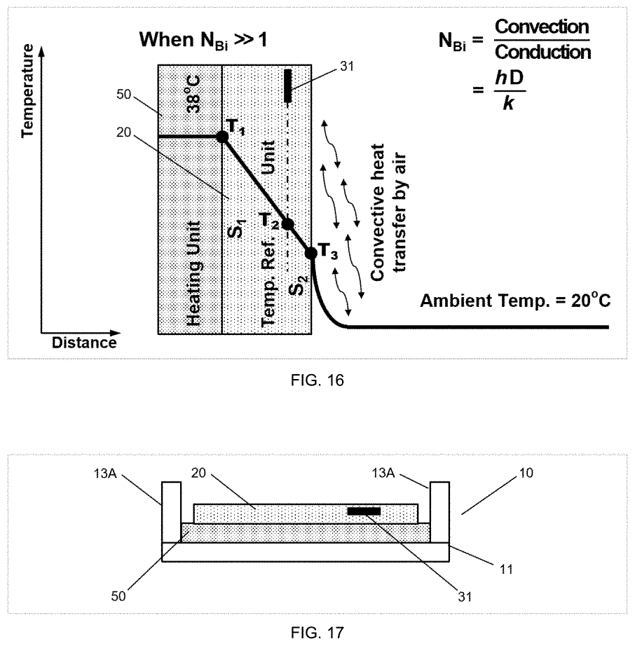

FIGS. 15 and 16 show diagrams which illustrate exemplary temperature profile across a temperature reference systems when a heating unit of the system heats the unit and maintains its temperature at a preset temperature. In FIGS. 15 and 16, an ordinate is a temperature, and an abscissa is a distance perpendicular to a top surface of the temperature ref. unit of the temperature ref. system.

As discussed above, a temperature ref. system may include a heating or cooling unit. A control unit may control the heating or cooling unit in order to respectively provide heat to the temperature ref. unit or to absorb heat therefrom, thereby trying to maintain a temperature of the temperature ref. unit at a preset temperature.

The temperature ref. systems in FIGS. 15 and 16 may include a heating unit (50), where a control unit controls the temperature of the heating unit, e.g., at 38° C. It is assumed that a temperature of an ambient air is kept constant, e.g., at 20° C. Although not shown in FIGS. 15 and 16, the temperature ref. system may also include the cooling unit.

Two different heat transfer mechanisms generally operate into and out of the temperature ref. unit. The first mechanism is the thermal conduction which allows heat generated by the heating unit to be transported to the temperature ref. unit at a first surface or a first interface denoted by S₁, whereas the second mechanism is the thermal convection which allows the temperature ref. unit to lose heat to the ambient air at a second surface or a second interface denoted by S₂. It is appreciated that the top surface of the temperature ref. unit described above corresponds to S₂.

FIGS. 15 and 16 exemplify the temperature ref. unit which is in a steady state in which a net amount of heat delivered to the unit by the heating unit is equal to a net amount of the dissipated from the unit into the ambient air. As a result, there is no net accumulation of heat inside the temperature ref. unit.

Thus, a temperature profile across the temperature ref. unit becomes linear as exemplified in FIGS. 15 and 16 such that the temperature decreases from a first surface (S₁) of the temperature ref. unit to an opposite, second surface (S₂) thereof. It is appreciated that the first surface (S₁) corresponds to a first interface between the heating unit and the temperature ref. unit, while the second surface (S₂) is a second interface between the temperature ref. unit and the ambient air.

More particularly, the first surface (S₁) may be maintained at 38° C., for the heating unit is controlled to generate heat to keep that temperature. At a second surface (S₂), however, the heat delivered by the heating unit across the temperature ref. unit is dissipated into the ambient air. As a result, the temperature at the second surface has to be lower than that of the first surface.

When a sensing unit (31) is disposed inside the temperature ref. unit (i.e., between S₁ and S₂), the temperature measured by the sensing unit (31) is lower than the temperature of the heating unit (50) but higher than that of the ambient air. Therefore, the temperature measured by the sensing unit (31) usually lies between the temperature at the first surface (or heating unit) and that of a pink body.

But an IR camera which receives the IR rays emitted from the pink body measures the temperature of the pink body which less than that measured by the sensing unit (31). This may mean that, when the IR camera measures the temperature of a pink body, regards the measured temperature to be the same as the temperature measured by the sensing unit (31) (i.e., somewhere between 38° C. and the ambient air temperature), and takes that temperature of the pink body as a reference temperature, the IR camera inherently commits errors in calibrating a target temperature.

For example, when a sensing unit (31) measures 37° C. but an actual temperature of the first surface (or pink body) is 36° C., an IR camera may misunderstand that the first surface (or pink body) is at 37° C., not 36° C. As a result, the IR camera may obtain a reference temperature of 37° C. from the pink body, although the actual temperature of the pink body is 36° C.

When the IR camera of the above two paragraphs examines a target and measures his or her temperature as 37.5° C., the actual temperature of the target has to be higher than 37.5° C., e.g., 38.5° C. In an unfortunate case, the target may have a fever or may suffer from a hyperthermia, but the IR camera (however expensive or accurate it may be) may treat a sick person as a normal person. Due to the above inherent errors, there is a danger that the IR camera may mis-identify a sick person as a normal subject.

When the sensing unit (31) is implemented flush with the first surface of the temperature ref. unit, the sensing unit (31) may correctly measure the temperature at 38° C. However, this temperature is far off from a temperature of a pink body disposed at a second surface of the temperature ref. unit. Because the heat is dissipated into an ambient air at the second surface, the real temperature of the pink body has to be low lower than the temperature measured by the sensing unit (31). Therefore, when an IR camera uses the temperature measured by the sensing unit (31) as a reference temperature, the IR camera has to includes errors in measuring a temperature of a target.

When the sensing unit (31) is implemented flush with the second surface of the temperature ref. unit, the temperature of the pink body which is measured by IR camera may be even lower than the one measured by the sensing unit (31) disposed inside the temperature ref. unit (20). Furthermore, the IR camera may not be able to use the temperature measured by the sensing unit (31) as a reference temperature, for the IR camera may not estimate the actual temperature measured by the sensing unit (31). Accordingly, the measurement of the IR camera still includes errors.

In other words, the temperature of the pink body (corresponding to a portion of the second surface) is prone to be different from the preset temperature which the temperature ref. system is desired to maintain through its control unit at the first surface, where the control unit controls the heating and/or cooling unit to maintain that preset temperature. In addition, the temperature of the pink body measured by the IR camera tends to be different from the preset temperature maintained by the control unit.

Therefore, there is a need to correct or compensate for such errors inherent in the temperature ref. unit caused by the thermal conduction and convection. To this end, various temperature ref. systems of this disclosure may employ various configurations or may be fabricated by various methods for accurately assessing a temperature of the pink body, thereby using the corrected or compensated temperature of the pink body as the reference temperature provided to the IR camera.

As discussed above, the thermal conduction (i.e., conductive heat transfer) and the thermal convection (i.e., convective heat transfer) operate into and out of the temperature ref. unit. A ratio of the convective heat transfer to the conductive heat transfer may be typically described by a dimensionless number called Biot number (N_{Bi}) which is conventionally defined as follows:

N_{Bi}=h D/k (Eq. 1)

where h is a convective heat transfer coefficient at the second surface (or interface) of the temperature ref. unit, D represents a characteristic length of a geometry considered, and k is a thermal conductivity of the temperature ref. unit. In the examples of FIGS. 15 and 16, D may represent a length along the abscissa, i.e., the thickness of the temperature ref. unit.

The Biot number is very useful in representing a relative importance of the thermal convection compared to the thermal conduction. For example, when N_{Bi} is far greater than 1.0, the thermal convection may be a predominant mechanism of heat transfer for a certain system, whereas the thermal conduction may become a predominant mechanism of heat transfer when N_{Bi} is far less than 1.0.

FIG. 15 is a case where N_{B}; is far less than 1.0, where the thermal conduction dominates over the thermal convection. In other words, because the convective heat transfer coefficient at the second surface or interface (S₂) times the characteristic dimension (e.g., a thickness of a temperature ref. unit) is very smaller than the thermal conductivity of the temperature ref. unit, a temperature profile across the temperature ref. unit is linear but relatively flat.

In this case, a temperature difference between the first and second surfaces is not so big. As a result, a temperature of a pink body measured by the sensing unit (31) may be somewhat closer to that of the preset temperature, i.e., 38° C., which is maintained by a heating unit at S₁.

However, FIG. 16 is a case where N_{Bi} is far greater than 1.0, where the thermal convection dominates over the thermal conduction. In other words, because the convective heat transfer coefficient at S₂ times the characteristic dimension is far greater than the thermal conductivity of the temperature ref. unit, a temperature profile across the temperature ref. unit is linear but relatively steep. In other words, a temperature difference between the first and second surfaces is far greater than that of FIG. 15.

FIGS. 15 and 16 delineate several embodiments capable of minimizing the above errors which may be inherent in the temperature ref. systems and their temperature ref. units, and capable of forcing a temperature of a pink body to more closely approach a temperature measured by a sensing unit.

As a result, an IR camera may more effectively utilize the temperature of the pink body as the reference temperature in assessing the temperature of a target. It is noted in this eighth exemplary aspect that the sensing unit may be implemented on the first surface, on the second surface or in-between, although one position may be a slightly better than another position in different examples.

In a first embodiment of this eighth exemplary aspect, a temperature reference unit may be made of or include a material exhibiting a high thermal conductivity. Increasing the thermal conductivity of the temperature ref. unit may increase a denominator of Eq. 1 and decrease N_{Bi}. Thus, the reference temperature provided by the pink body to an IR camera may be closer to the temperature which is measured by the sensing unit.

To this end, the temperature ref. unit (or pink body) may be made of a single material, a single alloy or a single composition. However, different portions of the temperature ref. unit (or pink body) may be made of different materials which have different thermal conductivities.

Different portions of the temperature ref. unit (or pink body) may be formed in a horizontal direction or in a vertical direction. Such a temperature ref. unit (or pink body) may be viewed as a set of pizza slices when such portions are provided in the horizontal direction, may be viewed as a layered cake when the portions are provided in the vertical direction, and the like.

In the above configuration, the portion which corresponds to the pink body or which includes the pink body may be preferred to be made of or include those materials with higher thermal conductivity than the rest of such portions.

In a second embodiment of this eighth exemplary aspect, a temperature reference unit may be made as a thin object. As a result, the parameter “D” of Eq. 1 becomes smaller, the numerator of Eq. 1 also becomes smaller, and N_{Bi} decreases. The temperature measured by a sensing unit may then become closer to that of the pink body. Therefore, the reference temperature provided by the pink body to an IR camera may be closer to the temperature which is measured by the sensing unit.

The thickness of the temperature ref. unit (or pink body) (e.g., “D”) may be determined while considering its heat capacity. When the temperature ref. unit (or pink body) is too thin, its mass decreases and, as a result, its hear capacity decreases. Therefore, a temperature of the temperature ref. unit (or pink body) may rapidly decrease even due to a small increase in the heat loss to a cool ambient air or due to a small increase in the heat transfer by a hot ambient air.

In contrary, when the temperature ref. unit (or pink body) is too thick, its heat capacity increases and, as a result, the temperature of the temperature ref. unit (or pink body) may change to a less degree due to a small change in the heat loss (or transfer). However, this causes an increase in the parameter “D” and results in an increase in the Biot number.

Thus, the thickness of the temperature ref. unit (or pink body) (e.g., “D”) may be determined while balancing an increase in a magnitude of “D” against a decrease in a heat capacity. For example, “D” may range from a few to several millimeters to a few centimeters.

It is noted that selection of the suitable thickness of the temperature ref. unit (or pink body) may not be a critical issue as long as a heating (or cooling) unit may be able to maintain the temperature of the first surface at the preset temperature.

In a third embodiment of this eighth exemplary aspect, a temperature reference unit may be made in such a way that the parameter “h” becomes smaller, which in turn decreases the numerator of Eq. 1 and which also decreases N_{Bi}. As a result, a temperature measured by a sensing unit may become closer to that of the pink body.

Therefore, the reference temperature provided by the pink body to an IR camera may be closer to the temperature which is measured by the sensing unit. To this end, the temperature ref. unit or the temperature ref. system may be fabricated to have various configurations or may be operated in various methods.

In a first example of this third embodiment, a user may operate a temperature ref. system in an environment in which a movement of air (or an air flow) may be minimized. By minimizing the air flow near the second surface, a forced convection may be minimized and the resulting convective heat transfer may also be minimized. As a result, “h” may also be minimized, N_{Bi} may be kept at a minimal value.

FIG. 17 is a cross-section of an exemplary temperature reference system (10) including a temperature ref. unit (20) and at least one air guard (13A) placed around a perimeter of the temperature ref. unit (20). As shown in the figure, the air guard (13A) extends vertically and surrounds the sides of the temperature ref. unit (20). Accordingly, the air guard (13A) may prevent or minimize the air flow which is directed to the temperature ref. unit (20).

The air guard (13A) may have a suitable shape and size enough to block the air flow. Therefore, as long as an IR camera can see a pink body of the temperature ref. unit (20), the air guard (13A) may have any width, height or thickness. The air guard (13A) may cover an entire perimeter of the temperature ref. unit (20) (or pink body). Alternatively, the air guard (13A) may cover only a portion of the perimeter of the temperature ref. unit (20) (or pink body).

In some cases, there may exist some air movements and the user cannot eliminate such air flow. In such cases, the user may install the temperature ref. system in such a way that its temperature ref. unit may not directly face the moving air, as long as an IR camera may see the temperature ref. unit and measure a temperature of the pink body.

In a second example of this third embodiment, the temperature ref. system may include an air guard which may be disposed around or over the temperature ref. unit. By blocking or minimizing an air flow which is directed to the second surface of the temperature ref. unit, the temperature ref. system may minimize “h” as well as the convective heat transfer due to the forced convection.

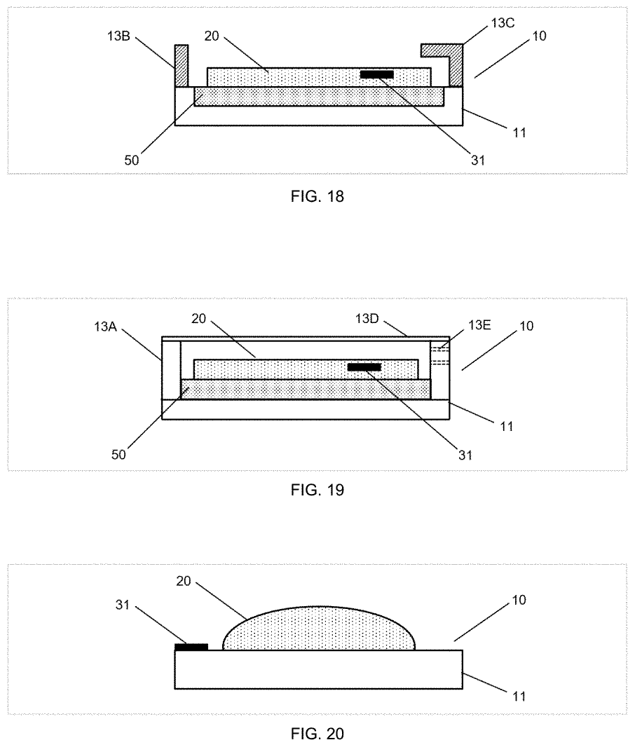

FIG. 18 is a cross-section of another exemplary temperature reference system (10) which includes a temperature ref. unit (20) and which also includes air guards (13B), (13C) placed around and over the temperature ref. unit (20).

As shown in the figure, a vertical air guard (13B) extends vertically and surrounds at least a portion of the side of the temperature ref. unit (20), similar to that (13A) in FIG. 17. However, a horizontal air guard (13C) may cover at least a portion of a second surface. Thus, the air guards (13B), (13C) may prevent or minimize the air flow directed to the temperature ref. unit (20) in both horizontal and vertical directions.

Such vertical and horizontal air guards (13B), (13C) may be shaped and sized in various dimensions. For example, the vertical air guard (13B) may cover a portion of the perimeter of the temperature ref. unit (20) (or pink body), while the horizontal air guard (13C) may cover, e.g., about a half of a second surface of the temperature ref. unit (20) (or pink body).

It is appreciated that the emission of IR rays or photons originates from atoms or molecules, typically disposed within a few millimeters from a surface. Therefore, when the horizontal air guard covering a pink body is thicker than a few millimeters, an IR camera which sees the pink body may rather end up measuring not the temperature of the pink body but that of the horizontal air guard. Thus, when the air guard of this second example is to cover at least a portion of the pink body, the air guard may be fabricated to be relatively thin, e.g., less than 3 mm, 2 mm, 1 mm, 0.5 mm, 0.1 mm, or the like.

In a third example of this third embodiment, the air guard may be shaped and sized to enclose the temperature ref. unit (or its pink body) therein. That is, the air guard may be viewed as a housing in which the temperature ref. unit (or its pink body) sits. Such an air guard may very effectively minimize the effects from the forced convection. The air guard of this third example may be fabricated similar to that of the second example such that its thickness may be less than, e.g., 3 mm, 2 mm, 1 mm, 0.5 mm, 0.1 mm, or the like.

FIG. 19 is a cross-section of another exemplary temperature reference system (10) which includes a temperature ref. unit (20) and which also includes air guards (13A), (13D) placed around and over the temperature ref. unit (20) or its pink body. As shown in the figure, the air guard (13A) may extend vertically and surround the side of the temperature ref. unit (20). Thus, the air guard (13A) may prevent or minimize the air flow which is directed to the temperature ref. unit (20).

In addition to the vertical air guard (13A), an additional horizontal air guard (13D) may be placed to cover the entire second surface of the temperature ref. unit (20) (or pink body). As a result, such air guards (13A) (13D) may completely block the air flows directed into the temperature ref. unit (20) (or pink body).

It is appreciated in this example that a temperature inside the air guards may keep increasing (when the temperature ref. system includes a heating unit) or decreasing (when the temperature ref. system includes a cooling unit). In order to prevent or minimize such changes in the temperature inside the air guards, openings (13E) may be formed around the air guard (13A), (13D) so that accumulated heat may be dissipated into the ambient air or the ambient heat may enter the air guard.

In a fourth example of this third embodiment, a second surface of the temperature ref. unit (20) (or pink body) may be made of, may include or may be coated by a hydrophobic material.

It is well documented that the parameter “h” at an interface may increase hundreds or thou-sands times when a liquid or moisture wets the interface. Accordingly, by preventing or minimizing wetting at the second surface, the temperature ref. system may minimize “h” as well as the convective heat transfer due to the forced convection.

To this end, an entire portion of a temperature ref. unit or its pink body may be made of or include a hydrophobic or non-polar material such that the unit or pink body may not be easily wet by water or vapor. Or the horizontal air guard discussed above may be similarly fabricated in order to prevent or at least minimize wetting by water or vapor.

In a fourth embodiment of this eighth exemplary aspect, a temperature reference unit may be made in any preferable shape or size in such a way that the Biot number may be far greater than 1.0, close to 1.0 or far less than 1.0. An IR camera may then assess a temperature profile across a temperature ref. unit and calculate a temperature of a pink body of the temperature ref. unit. This embodiment presupposes that various values of some system variables and/or parameters are known in advance.

When a certain temperature reference system is selected and deployed in order to provide at least one reference temperature to an IR camera or processor, a thickness of a temperature ref. unit (or pink body) which is “D” of Eq. (1), a thermal conductivity of the temperance ref. unit (or pink body) which is “k” of Eq. (1), an exact location of a sensing unit (with respect to the temperature ref. unit or pink body) are all known system parameters.

In addition to such known system parameters, there may be at least a few known system variables. For example, a temperature at the first surface (S₁) (i.e., T₁ of FIGS. 15 and 16) is a known variable, for a control unit of the temperature ref. system may control a heating or cooling unit and maintain T₁ at a preset temperature, where T₁ may be preset in advance by a temperature ref. system, an IR camera or a user, or where T₁ may be adjusted later by the system, IR camera or user.

The temperature measured by at least one sensing unit may vary over time but that temperature is anyway another known system variable. When the temperature ref. system includes another sensing unit or a thermometer capable of measuring a temperature of an ambient air, the ambient temperature is another known variable.

Furthermore, when the temperature ref. system or its user may prevent a flow of ambient air toward or near the pink body or may maintain such an air flow in a relatively uniform condition, a convective heat transfer coefficient at the second surface, i.e., “h” of Eq. (1) may be known or at least estimated. Alternatively, the value of “h” may be estimated based upon the flow rate or direction of the ambient air, humidity of air, or the like.

In a first example of this fourth embodiment, a temperature ref. system, IR camera or processor may calculate N_{Bi} and assess whether or not the conductive heat transfer may dominate over the convective heat transfer, using the aforementioned values of the known variables and parameters.

The temperature ref. system, IR camera or processor may then estimate the temperature of the pink body using such values of the known variables and parameters. The IR camera or processor may then use the estimated temperature of the pink body as the reference temperature when measuring a temperature of a target.

In a second example of this fourth embodiment, the temperature ref. system, IR camera or processor may estimate the temperature of the pink body indirectly from a temperature at the first surface (S₁) and another temperature measured by a sensing unit.

As shown in FIGS. 15 and 16, it is assumed in a steady state that the temperature profile is relatively linear along the thickness of the temperature ref. unit. Accordingly, by knowing the exact location of the sensing unit, the temperature of the pink body may be estimated from other two temperatures using such a linear fashion.

In a fifth embodiment of this eighth exemplary aspect, at least one sensing unit may be incorporated on a second surface (or interface) of a temperature ref. unit. A temperature ref. system may regard a temperature measured by a sensing unit as a temperature of a pink body, and an IR camera may use the temperature measured by the sensing unit as a reference temperature in measuring a temperature of a target.

A sensing unit may be incorporated in any position on or around a temperature ref. system as far as the sensing unit is exposed to the ambient air and measures the temperature of the ambient air. FIG. 20 is a cross-section of an exemplary temperature reference system (10) with at least one sensing unit (31) implemented on a top surface of a body (11) of the system (10). As shown in the figure, the sensing unit (31) is directly exposed to an ambient air, and measures the ambient temperature. It is noted that the sensing unit (31) may be spaced away from a temperature ref. unit (20) as well.

Even when the temperature ref. system (10) may provide an IR camera with the ambient temperature as a reference temperature, the IR camera may still see a pink body of the temperature ref. unit (20), and regards the temperature of the pink body as the reference temperature. It is preferred therefore that the pink body is exposed to the ambient air as much alike as the sensing unit is exposed to the ambient air.

Configurational features, manufacturing features, use features, their modifications or their variations of the above eighth exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The ninth exemplary aspect of this disclosure relates to detailed configurations of a pink body and a temperature reference unit.

As discussed above, a temperature ref. unit may incorporate at least one temperature ref. sub-unit which may in turn define therein or thereon at least one “pink body.” As far as an IR camera (including a computer or an image processor) can recognize the pink body from an image captured by the IR camera, the pink body may be fabricated in various sizes, e.g., in the range of micrometers, millimeters or centimeters.

Because a pink body may be at best as large as a top surface of a temperature ref. unit, the temperature ref. unit may also have the dimension in the range of micrometers, millimeters or centimeters. Therefore, a manufacturer may consider various factors in selecting the size of the pink body, temperature ref. unit, or the like.

The first of such factors is the required accuracy. For example, a temperatures of a top surface of a temperature ref. unit may vary to some extent, e.g., from one location to another location. As a result, measuring the temperature of a single point on the pink body may increase the error. Thus, when other things being equal, the temperature ref. unit with a larger top surface would generally allow the IR camera to measure the temperature of the pink body at multiple points and to get averages thereof, thereby decreasing measurement errors.

It is appreciated that an accuracy of the measured temperature also depends on the resolution of an IR camera, a size and a number of pixels of the IR camera, and so on, such that an optimum size of a temperature ref. unit or its pink body may be selected in a relative sense, e.g., with respect to such resolution, pixel size, pixel numbers, or the like.

The second of such factors is a distance from a temperature ref. unit (or pink body) to an IR camera. In general, the greater the distance, the temperature ref. unit or its pink body would look smaller in the image which is captured by the IR camera. This means that the temperature ref. unit or its pink body may correspond to a smaller number of pixels, and this may also result in the inaccuracy in the measured temperature of the pink body. Therefore, when other things being equal, a larger or bigger temperature ref. unit (or pink body) would suit better when the temperature ref. unit is to be positioned in a greater distance from an IR camera. The resolution of the IR camera and a number of its pixels may be considered as discussed above.

The third of such factors is the spatial or temporal perturbation in the ambient conditions. When the temperature of an ambient air changes a lot or very fast due to, e.g., air conditioning, fan, or the like, the temperature of the top surface of the temperature ref. unit may also change significantly or faster.

Sunlight through a window may vary an amount of photons or IR rays emitted by a temperature ref. unit (or its pink body) as well, particularly when the window is small so that the pink body may not uniformly receive the sunlight. This situation may get worse when only a portion of the top surface of the temperature ref. unit receives the sunlight but the rest of the temperature ref. unit does not, or when the temperature ref. unit moves such that different portions of unit receive the sunlight according to its movement.

Such perturbation in ambient conditions may then cause variations in local temperature on the temperature ref. unit. Therefore, the temperature ref. unit including the larger top surface may allow the IR camera to obtain temperatures of different portions of a temperature ref. unit and then to obtain an average temperature.

It is noted, however, that the larger temperature ref. units may not always be beneficial. That is, the above considerations do not always mean that a temperature ref. unit including a larger or wider top surface is always beneficial. For example, a larger temperature ref. unit may mean a higher cost. In addition, it would be more difficult to work with a bulky temperature ref. unit. Furthermore, a larger top surface of the temperature ref. unit may accompany different local temperatures.

Accordingly, the temperature ref. unit may be fabricated in such a way that an area of its top surface may be in the range of [1] less than 0.1 cm² (for a ultra-small temperature ref. unit), [2] between 0.1 and 1 cm² (for a miniature unit), [3] between 1-10 cm² (for a small unit), [4] between 10-100 cm² (for a medium unit), [5] larger than 100 cm² (for a large unit) or [6] larger than 1,000 cm² (for a super unit).

The temperature ref. unit, its top surface or its pink body may also have various shapes such as, e.g., a rectangular shape, a square shape, other polygonal shapes, a circular shape, an oval shape, or the like. In addition, a top surface of a temperature ref. unit may be symmetrical or asymmetrical.

As discussed above, a manufacturer may also select a size of the temperature ref. unit (or pink body) while considering one or more of the following factors such as, e.g., [1] the required accuracy, [2] the distance from the temperature ref. unit (or pink body) to an IR camera, [3] the perturbation in the ambient conditions, [4] the shape or the size of the sensing unit, [5] power consumption, or [6] other considerations which a manufacturer may feel important.

Configurational features, manufacturing features, use features, their modifications or their variations of the above seventh exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The tenth exemplary aspect of this disclosure relates to detailed configurations of a sensing unit of a temperature reference system.

Various prior art temperature sensors may be included in the sensing unit. Examples of the prior art sensors may include, but not limited to, thermocouples, resistor temperature detectors, thermistors, semiconductor temperature sensors (sometimes referred to as IC temperature sensors), or the like. Detailed examples of the semiconductor temperature sensors may include, e.g., current output temperature sensors, voltage output temperature sensors, resistance output silicon temperature sensors, diode temperature sensors, digital output temperature sensors, or the like.

A manufacturer may consider various factors in selecting a proper temperature sensor of the sensing unit, for different temperature sensors may usually have different operational features such as, e.g., a temperature range, an accuracy, a response time, a linearity, stability, or the like. A manufacturer may resort to a variety of sources which explain and compare different features of different temperature sensors, where such sources may include [1] Thomas A. Hughes, “Measurement and control basics” (5^{th} ed.) ISA (2015); refer to Ch. 7, [2] “Temperature probes: how to choose the right temperature sensor type,” Omega (source: https://www.omega.co.uk/temperature/z/thermocouple-rtd.html, or the like.

Configurational features, manufacturing features, use features, their modifications or their variations of the above tenth exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The eleventh exemplary aspect of this disclosure relates to various variations or modifications of the pink bodies, temperature reference units, and other units of various temperature reference systems of this disclosure.

The first embodiment of this eleventh exemplary aspect relates to a temperature reference unit with various layered structures. For example, a top surface of a temperature ref. unit may be coated with at least one coating layer. The coating layer may serve various functions such as, e.g., [1] protecting a top surface of the temperature ref. unit from mechanical scratches, abrasion or shock, [2] protecting a top surface of the temperature ref. unit from water, moisture, vapor or other liquids by including a water-resistant or water-repelling material on or in the coating layer (e.g., a hydrophobic or non-polar material), [3] minimizing reflection of the IR rays or photons by a top surface, e.g., by fabricating the coating layer with a material with low reflection coefficient, or by treating a coating layer to have low reflectance.

The coating layer may also serve to increase an IR-ray emissivity of a top surface of a temperature ref. unit, e.g., [1] by painting the top surface with a thermographic paint with a high emissivity, [2] by fabricating the coating layer with a material with a high emissivity, [3] by the coating layer with a material with a known emissivity (which may not be necessarily high), or the like, where an IR camera may calibrate the measured temperature of a pink body (or temperature ref. unit) while considering that known emissivity of the temperature ref. unit.

The coating layer may also serve to increase the IR-ray emissivity of a top surface of the temperature ref. unit, e.g., [1] by rendering the coating layer to play the role of a black body simulator such as, e.g., providing multiple cavities on or through the coating layer, or [2] by maintaining a uniform temperature across the entire or at least a substantial portion of the top surface by, e.g., fabricating the coating layer with a material that may have a high thermal conductivity, may have a low heat capacity, or the like.

It is appreciated that the IR-ray emissivity of various materials are provided in a variety of sources. For example, Thermoworks discloses the IR-ray emissivity of about 90 different materials in its web-site (see reference 1), and Optotherm provides discloses the IR-ray emissivity of about 140 different materials in its web-site (see reference 2).
Reference 1:
https://www.thermoworks.com/emissivity-table
Reference 2:
https://www.optotherm.com/emiss-table.htm#:˜:text=Emissivity%20is%20a%20 measure%20of%20%20material's%20radiating%20efficiency.&text=Tables%20of%20emissivity%20values%20are.by%20surface%20roughness%20or%20finish, or the like.

Various layers of the temperature ref. unit may be provided in various configurations. As discussed above, a typical temperature ref. unit may include a single layer with a uniform thickness. However, the temperature ref. unit may have a thicknesses that may vary along its long axis or a short axis. When the temperature ref. unit includes at least one coating layer, its height, length, width or radius of the coating layer or of the temperature ref. unit may vary in such a way that, e.g., the coating layer may be wider (or narrower), longer (or shorter), thinner (or thicker) or the like, than the temperature ref. unit.

The second embodiment of this eleventh exemplary aspect relates to configurations and methods for controlling a temperature of a temperature reference unit or its pink body.

As explained above, the temperature ref. unit may include multiple temperature ref. sub-units, where a control unit may control the sub-units such that each sub-unit is maintained at a preset reference temperature. When the temperature ref. unit includes multiple sub-units, the control unit may then control the temperatures of such sub-units at the same or different values, thereby providing a single or multiple identical or different reference temperatures to an IR camera.

The control unit may instead vary temperatures of the sub-units, e.g., [1] by varying the reference temperature of each sub-unit based on the preset sequence, e.g., at 36° C. for 15 min., at 37° C. for 15 min., and then back to 36° C., [2] by varying the reference temperature of such a sub-unit randomly. [3] by varying the reference temperature according to a command which may be issued by an IR camera, a computer, an image processor, or a user of the IR camera, computer, image processor, or the like.

For example, the control unit may manipulate a temperature of a single temperature ref. sub-unit to be at one of multiple different ref. temperatures, where the temperature of the sub-unit may vary over time. In this case, the single sub-unit may be deemed to play the role of multiple temperature ref. sub-units. A typical temperature ref. unit may not have to respond fast and, thus, this single sub-unit configuration may be feasible.

The third embodiment of this eleventh exemplary aspect relates to a variety of control algorithms of a control unit of a temperature reference system, where the control unit may manipulate a heating or cooling unit while aiming to maintain a temperature measured by a sensing unit at about the preset temperature.

It is appreciated that the control unit of the temperature ref. system of FIGS. 15 and 16 manipulates a temperature of the first surface of the temperature ref. unit at a preset temperature. Therefore, as long as the sensing unit may not be disposed at the first surface, the temperature at the first surface is generally different (e.g., higher when a heating unit operates or lower when a cooling unit operates) from the temperature measured by the sensing unit.

The temperature ref. system of FIGS. 15 and 16 may also require at least one sensing unit when the system measures the temperature at the first surface, e.g., between the unit and a heating unit.

In contrary, the control unit of this third embodiment of the eleventh aspect may directly manipulate a heating or cooling unit in order to maintain the temperature measured by the sensing unit to be at the preset temperature. As a result, in this configuration, not T₁ but T₂ of FIGS. 15 and 16 becomes the known system variable.

This embodiment may offer various advantages. First of all, this embodiment does not require any additional sensing unit other than the one illustrated in FIGS. 15 and 16. Accordingly, the cost of the system may be kept minimal, and the system may be made in a more compact configuration.

Secondly, when the sensing unit may be positioned closer to the second surface of the temperature ref. unit and maintain the temperature measured by the sensing unit at the preset temperature, then the temperature of the second surface may become closer to the preset temperature than the cases as exemplified in FIGS. 15 and 16. Therefore, those errors which may be inherent in the temperature ref. system (as discussed in the eight exemplary aspect) may be minimized as well.

The fourth embodiment of this eleventh exemplary aspect relates to installing a sensing unit relatively or very proximate to a pink of a temperature reference unit of a temperature reference system.

As discussed above, when a (horizontal) distance from a sensing unit to a second surface in FIGS. 15 and 16 increases, a difference between a temperature measured by the sensing unit (T₂ in those figures) and a temperature of a temperature ref. unit (or pink body) (T₃ in those figures) increases. As a result, an IR camera may have to account for the difference in Tₛ and T₃ in assessing an accurate reference temperature.

But when a sensing unit is disposed very close to a pink body as in this embodiment, the temperature (T₂) measured by the sensing unit may approach the temperature of the pink body (T₃). In this case, the IR camera may treat T₂ as T₃ and may easily obtain T₂ as the reference temperature, e.g., directly from a signal (representing T₂) delivered by the sensing unit to the temperature reference system or the IR camera.

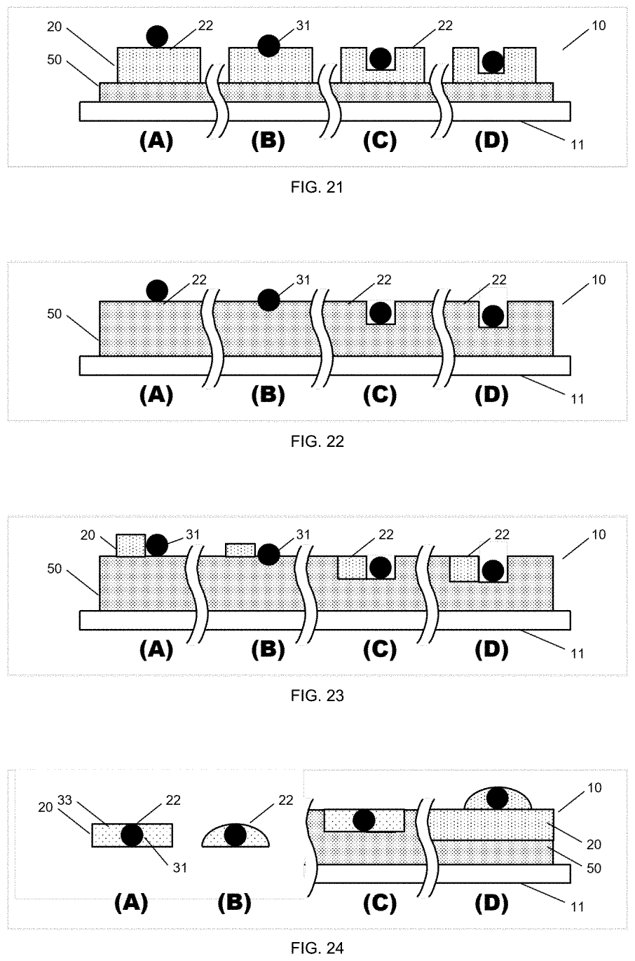

Following FIGS. 21 to 24 are cross-sections of various temperature reference systems which include sensing units and pink bodies, where the pink bodies may be implemented according to the above configurations of the preceding paragraph. It is noted throughout this disclosure that a cross-section is an illustrative view of a temperature ref. system which is to be positioned and used in such a way that an IR camera is to be positioned on top of the temperature ref. system.

As a result, the IR camera looks down on a temperature ref. system, and detects a temperature of a pink body of a temperature ref. unit. The IR camera may use the detected temperature of the pink body as a reference temperature in estimating a temperature of a target.

In FIGS. 21 to 24, a heating unit is represented as rectangles with a dark hatching, and a temperature ref. unit is represented as rectangles with a light hatching. For simplicity of illustration, cross-sections of prior art sensing units are shown as black circles in FIGS. 21 to 24, where examples of such prior art sensing units may include a thermocouple, a thermistor, or the like. Of course different prior art sensing units may have different cross-sections.

FIG. 21 is a cross-section of an exemplary temperature reference system (10) including at least one sensing unit (31) which may be disposed very close to a pink body (22) in various spatial relations. The temperature ref. system (10) may minimize a difference between a temperature (T₂) measured by a sensing unit (31) and a temperature (T₃) of a pink body (22).

The panel (A) of FIG. 21 shows a configuration where a sensing unit (31) sits on top of a temperature ref. unit (20) or its pink body (22), while the sensing units (31) of the panels (B) and (C) are partially or completely embedded in the temperature ref. unit (20), respectively. The sensing unit (31) of the panel (D) is enclosed inside the temperature ref. unit (20), e.g., inside a cavity formed on a body (11) of the temperature ref. system (10).

As discussed above and in FIG. 21, the pink body (22) corresponds to an entire or only a portion of a top (or second) surface of the temperature ref. unit (20). In all of the panels, the sensing unit (31) is implemented very close to the pink body (22) so that T₂ and T₃ may be very close to each other. Therefore, an IR camera may receive a signal representing T₂ and then may treat T₂ as a reference temperature, where the temperature ref. system (10), IR camera or processor may select a specific shape or size of the pink body.

It is noted that, when the sensing unit (31) is more exposed to an ambient air, e.g., as in the panels (A) and (B), the sensing unit (31) may receive more heat from a hot ambient air or lose more heat to a cold ambient air. Therefore, when a user installs and uses the temperature ref. system (10), the user may carefully select a location as well as an orientation which may minimize a direct air flow to the pink body, thereby preventing or at least minimizing the above errors caused by the convective heat transfer into or out of the temperature ref. unit (20).

Alternatively, it may be desirable to implement the sensing unit (31) and the pink body (22) in such a way that they may be exposed to the ambient air flow to the same or similar extent. The panels (B) to (D) may represent such arrangements, where the sensing unit and the pink body may be exposed to the ambient air flow similarly.

Therefore, when the ambient air flows toward the sensing unit (31) and the pink body (22), they may receive or lose (almost) the same amount of heat from or into the ambient air. As a result, even when T₂ and T₃ may change due to the ambient air flow, T₂ and T₃ may still remain almost the same.

When a top portion of a heating unit has a high IR-ray emissivity and, as a result, when an IR camera may accurately detect a temperature of a top portion of the heating unit from its thermal image (or detect the IR rays emitted by the top portion), a sensing unit may be disposed directly over or inside the top portion of the heating unit.

FIG. 22 is a cross-section of another exemplary temperature reference system (10) including at least one sensing unit (31) which is disposed over or around a top portion of a heating unit (50) in various spatial relations.

In this case, an IR camera may treat an entire (or only a) portion of the top portion of the heating unit (50) as a pink body (22), and treat a temperature of the top portion of the heating unit as a reference temperature. Therefore, the temperature ref. system (10) may not require any separate temperature ref. unit at all.

The sensing units (31) of the panels (A) to (D) are disposed on top of or inside the top portion of the heating unit (50) similar to those of the panels (A) to (D) of FIG. 21. Accordingly, further explanations are omitted.

It is appreciated that the above arrangement may be useful when the IR camera may readily receive the IR rays emitted by the top portion of the heating unit. However, when the top portion has a poor emissivity (i.e., not close to 1.0), the color of the pink body in the thermal image captured by the IR camera may not necessarily be accurate. In this case, a thin layer of a material which has a higher IR-ray emissivity may be coated, deposited or sprayed over the pink body and improve the emissivity of the pink body.

FIG. 23 is a cross-section of another exemplary temperature reference system (10), where a sensing unit may be disposed very close to a pink body (22) of a temperature reference unit (20) in various spatial relations and where both the pink body and sensing unit may be disposed over a heating unit.

It is noted that the temperature ref. system (10) includes the temperature ref. unit (20) which defines the pink body (22) right next to the sensing unit (20). As the pink body (22) may be made of or include those materials with a higher emissivity, the heating unit (50) may be made of any prior art material, regardless of its emissivity.

In addition and as shown in the figure, the pink bodies and sensing units of the panels (A) to (D) are disposed in a horizontal direction or side by side. An apex of the pink body and another apex of the sensing unit may be at the similar or identical elevation so that a distance from the apex of the pink body to an IR camera and a distance from the apex of the sensing unit to the IR camera may be the same or almost identical. As a result, this arrangement may prevent or minimize any error caused by the difference between such distances.

The fifth embodiment of this eleventh exemplary aspect relates to a temperature reference system including a sensing unit which may be used as a pink body itself. Because the sensing unit itself may serve as the pink body itself, the temperature ref. system may be fabricated as a compact article, an IR camera may then directly obtain a reference temperature from an amount of IR rays emitted by the sensing unit which itself is the pink body) and detected by the IR camera, thereby preventing or minimizing the aforementioned inherent errors due to complex heat transfer phenomena, or the like.

It is appreciated that such a sensing unit is preferably implemented to be exposed to an ambient air, for the IR camera has to receive the IR rays emitted by the sensing unit, to measure an amount of the IR rays emitted therefrom, and to match that temperature of the sensing unit with the amount.

Therefore, a prior art sensing unit such as a thermocouple or a thermistor, may be positioned on top of a heating unit, a cooling unit or a body of a temperature ref. system, and may be used as the pink body. That is, an IR camera may measure an amount of the IR rays emitted by the sensing unit, and may deem that amount of the detected IR rays to correspond to the temperature measured by the sensing unit.

It is noted that lots of conventional sensing units such as thermocouples or thermistors are fabricated in the shape of a sphere or an ellipsoid. Therefore, an outer surface of such a sensing unit may have a curvature of a sphere, an oval or an ellipse. Such a curvature may not be advantageous to an IR camera, for the IR camera may not be able to receive an amount of IR rays which may be enough to obtain the above relationship between the amount of the detected IR rays and the temperature measured by the sensing unit.

FIG. 24 is a cross-section of various exemplary sensing units which may be encapsulated and may have a top surface with an increased surface area. The panel (A) of FIG. 24 shows an encapsulation (33) in which a sensing unit (31) is enclosed. The encapsulation (33) has a shape of a rectangle or a cube and defines a top surface which is flat and has an area which may be significantly larger than that of the sensing unit (31) itself. The panel (B) of FIG. 24 is another encapsulation (33) which has a shape of a hemi-circle or a portion of an ellipsoid, and which defines a top surface which is less curved that the sensing unit (31) and has an area which is larger than that of the sensing unit (31) itself.

The encapsulated sensing unit (31) may be used in various modes. For example, the encapsulated sensing units (31) of the panels (A) and (B) may be used as the pink body and may be implemented in various positions around the temperature ref. system (10) or IR camera. Alternatively and as exemplified in the panels (C) and (D) of FIG. 24, the encapsulated sensing unit (31) may be placed on or inside a heating unit (50) or on or inside the temperature ref. unit (20).

It is appreciated in this fifth embodiment that a control unit may manipulate either a heating unit or a cooling unit in order to maintain [1] the temperature at the first surface at the preset temperature or [2] the temperature measured by the sensing unit at the preset temperature, where the sensing unit is not disposed on the first surface.

It is also noted in this fifth embodiment that the pink body may be fabricated to have a shape, a size, a height, a width, an elevation, a contour, a color or an emissivity which may be similar or identical to that of the sensing unit. As a result, when the ambient air flows toward the pink body and sensing unit, both of them may be subject to the similar or same extent of the forced thermal convection.

In addition, the pink body and sensing unit may be positioned at the similar or identical distance from the IR camera or the pink body and sensing unit are positioned in the similar or identical orientation with respect to the IR camera. As a result, the IR camera may also detect the IR rays emitted by the pink body and sensing unit under the similar or same condition.

Although various examples of this fifth embodiment relate to the temperature ref. system including a heating unit, the above configurations may similarly apply to the temperature ref. system which may include only a cooling unit or which may include both the heating and cooling unit each of which has been explained hereinabove.

Configurational features, manufacturing features, use features, their modifications or their variations of the above eleventh exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

The twelfth exemplary aspect of this disclosure relates to various relationships between an amount of IR rays (which are emitted by a pink body and then detected by an IR camera) and a signal which represents a temperature of the pink body (which is measured by a sensing unit).

In the first example, when the sensing unit may be disposed very close to the pink body and when the heat transferred to (or dissipated from) the sensing unit and pink may be identical or almost the same, the temperature which is measured by the sensing unit may be identical to or almost the same as the temperature of the pink body. Then an IR camera assembly, temperature reference system or IR camera may use a relationship between the temperature of the pink body and the amount of IR rays which are emitted by the pink body and then detected by the IR camera, while assuming that the temperature of the pink body is the same as the temperature measured by the sensing unit.

In the second example, when the sensing unit may be disposed by a certain distance from the pink body, the temperature measured by the sensing unit may not be identical to the temperature of the pink body. For example and referring to FIGS. 15 and 16, when the sensing unit is disposed inside the temperature reference unit and measures T₂, the pink body which is disposed on the second surface has the temperature of T₃, where T₃ may depend on various factors such as, e.g., a distance between the sensing unit and pink body, heat transferred from a heating unit to the temperature reference unit, heat lose to an ambient air by the thermal conduction (and/or convection).

In this case, heat transfer equations may be solved for a certain temperature reference unit as well as a certain pink body with known configurations. For example, for such configuration, a thickness and a thermal conductivity of a temperature reference unit are known, and a distance between the sensing unit and the pink body are known. Depending on operation conditions, a preset temperature (e.g., the temperature of the heating unit or cooling unit, T₁, at the first surface S₁) is also known. In addition, a temperature of an ambient air may be easily measured, T₂ is measured by the sensing unit, and “h” may also be known or estimated. Accordingly, an analytical equation for T₃ may be provided as a function of many variables and parameters such as, e.g., T₁, ambient temperature, T₂, h, or the like.

Alternatively, a manufacturer may experimentally obtain an equation which may be similar to that of the preceding paragraph, e.g., by performing experiments and, when desirable, by fitting results into a line, a parabola, or other curves. Or the manufacturer may perform such experiments and tabulate the results into a list or a table.

Such an analytical equation, an experimentally fitted equation, a table or a list may be used to obtain a more reliable temperature of a pink body (i.e., T₃). Accordingly, when the IR camera assembly, the temperature reference system or the IR camera uses a relationship between the temperature of the pink body and an amount of IR rays which are emitted by the pink body and then detected by the IR camera, T₃ obtained by the above equation, table or list may be used to obtain the temperature of the pink body.

Configurational features, manufacturing features, use features, their modifications or their variations of the above twelfth exemplary aspect may [1] apply to, [2] be incorporated into, [3] replace, [4] be replaced by, or [5] be combined with corresponding features of another exemplary aspect, embodiment, or example of this disclosure, as long as they do not contradict each other.

Unless otherwise specified, various features of a certain exemplary aspect, embodiment, example or objective of this disclosure may apply interchangeably to corresponding features of other aspects, embodiments, examples or objectives of this disclosure. Of course, such inter-changeability may be limited when such application, incorporation, replacement, or combination may contradict each other.

Various temperature reference systems, various units of such temperature ref. systems, various pink bodies, and various methods of fabricating, installing or using such systems, units or pink bodies have been disclosed hereinabove. It is to be understood that while various aspects, embodiments, and examples of this disclosure have been described in conjunction with detailed description provided hereinabove, the foregoing disclosure is intended to illustrate and not to limit the scope of the above temperature reference systems, temperature reference units of such systems, pink bodies, and methods. Other aspects, embodiments, examples, advantages, and modifications are within the scope of the following claims as well.

What is claimed is:

1. An IR camera assembly for measuring and calibrating a temperature of a target comprising:
a temperature reference system which comprises:
at least one sensing unit which measures its temperature and at least a portion of which is exposed to an ambient air;
at least one of a heating unit and a cooling unit disposed close to said sensing unit, wherein said heating unit generates heat, delivers said heat to said sensing unit, and increases said temperature of said sensing unit, and wherein said cooling unit absorbs heat from said sensing unit, and decreases said temperature of said sensing unit; and
a control unit for maintaining said temperature of said sensing unit at a preset temperature by manipulating said at least one of said heating and cooling units; and
an IR camera which detects a first amount of first IR rays emitted by said sensing unit and a second amount of second IR rays emitted by said target,
wherein said assembly obtains a relationship between said first amount of said IR rays and said temperature of said sensing unit, and
wherein said assembly determines a temperature of said target from said second amount of said IR rays using said relationship.

2. The assembly of claim 1, wherein said at least one of said heating and cooling unit includes a top portion, and wherein said sensing unit is disposed in one of:
on top of said top portion, wherein at least a substantial portion of said sensing unit is exposed to said ambient air;
inside a cavity which is formed in one of said heating and cooling units, where at least a portion but not an entire portion of said sensing unit is disposed inside said cavity; and
inside said cavity, where an entire portion of said sensing unit is disposed inside said cavity.

3. The assembly of claim 1, wherein said preset temperature falls between a low temperature and a high temperature, wherein said low temperature is one of 35° C., 36° C., 37° C., 38° C., and 39° C., wherein said high temperature is one of 37° C., 38° C., 39° C., 40° C., 41° C., and 42° C., and wherein said low temperature is less than said high temperature.

4. The assembly of claim 1, wherein said sensing unit is one of a thermocouple, a thermistor, and a resistance temperature detector.

5. The assembly of claim 1, further comprising an outer layer provided over an outer surface of said sensing unit, wherein said outer lay has an IR-ray emissivity which is greater than 0.9.

6. The assembly of claim 5, wherein said outer layer is one of deposited over, coated over, and sprayed on said sensing unit.

7. The assembly of claim 5, wherein said outer layer has a thickness which is less than one of 3 mm, 2 mm, 1 mm, 0.5 mm, and 0.1 mm.

8. The assembly of claim 1, wherein said preset temperature is determined by one of:
said temperature reference system;
a first user of said temperature reference system;
said IR camera;
a second user of said IR camera; and
a third user of said assembly.

9. The assembly of claim 1, wherein said assembly performs one of:
keeping said preset temperature at a constant value;
varying said preset temperature according to a preset sequence;
varying said preset temperature according to a temperature of said ambient air;
varying said preset temperature when said temperature of said target falls between a certain range; and
varying said preset temperature when said temperature of said target exceeds a certain value, wherein said certain value is greater than one of 37° C., 37.5° C., 38° C., 38.5° C., 39° C., 39.5° C., and 40° C.

10. The assembly of claim 1, wherein said temperature reference system includes at least two sensing units, and wherein said control unit maintains said temperatures of said sensing units at two preset temperatures.

11. The assembly of claim 10, wherein at least one of said sensing units is one of a thermocouple, a thermistor, and a resistance temperature detector.

12. The assembly of claim 10, wherein said two preset temperatures are one of:
different from each other; and
identical to each other.

13. The assembly of claim 12, wherein said assembly performs one of:
keeping at least one of said two preset temperatures at a constant value;
varying at least one of said two preset temperatures according to a preset sequence;
varying at least one of said two preset temperatures according to a temperature of said ambient air;
varying at least one of said two preset temperatures when said temperature of said target falls between a certain value; and
varying at least one of said two preset temperatures when said temperature of said target exceeds a certain value.

14. The assembly of claim 1, wherein said at least one of said heating and cooling units is a Peltier element.

15. The assembly of claim 1, wherein said sensing unit is one of fixedly and detachably coupled to said IR camera.

16. The assembly of claim 1, wherein said sensing unit is disposed closer to said target than said IR camera when said IR camera detects said first and second amounts of said IR rays.

17. An IR camera assembly for measuring and calibrating a temperature of a target comprising:
a temperature reference system which comprises:
a temperature reference unit defining a top surface which is exposed to an ambient air and which has an IR emissivity greater than 0.9;
at least one sensing unit which is disposed in said temperature reference unit and which measures a temperature of said temperature reference unit;
at least one of a heating unit and a cooling unit disposed adjacent to said temperature reference unit, wherein said heating unit generates heat, delivers said heat to said temperature reference unit, and increases said temperature of said temperature reference unit, and wherein said cooling unit is disposed adjacent to said temperature reference unit, absorbs heat from said temperature reference unit, and decreases said temperature of said temperature reference unit; and
a control unit for maintaining said temperature of said temperature reference unit at a preset temperature by manipulating said at least one of said heating and cooling units; and
an IR camera which detects a first amount of first IR rays emitted by at least a portion of said top surface of said temperature reference unit and a second amount of second IR rays emitted by said target,
wherein said assembly obtains a relationship between said first amount of said IR rays and said temperature of said sensing unit, and
wherein said assembly determines a temperature of said target from said second amount of said IR rays using said relationship.

18. The assembly of claim 17, wherein said sensing unit is disposed in one of:
on said top surface, wherein at least a substantial portion of said sensing unit is exposed to said ambient air;
inside a cavity which is formed in said top surface, where at least a portion but not an entire portion of said sensing unit is disposed inside said cavity; and
inside said cavity in which an entire portion of said sensing unit is disposed.

19. The assembly of claim 17, wherein said preset temperature falls between a low temperature and a high temperature, wherein said low temperature is one of 35° C., 36° C., 37° C., 38° C., and 39° C., wherein said high temperature is one of 37° C., 38° C., 39° C., 40° C., 41° C., and 42° C., and wherein said low temperature is less than said high temperature.

20. The assembly of claim 17, wherein said sensing unit is one of a thermocouple, a thermistor, and a resistance temperature detector.

21. The assembly of claim 17, wherein said preset temperature is determined by one of:
said temperature reference system;
a first user of said temperature reference system;
said IR camera;
a second user of said IR camera; and
a third user of said assembly.

22. The assembly of claim 17, wherein said assembly performs one of:
keeping said preset temperature at a constant value;
varying said preset temperature according to a preset sequence;
varying said preset temperature according to a temperature of said ambient air;
varying said preset temperature when said temperature of said target falls between a certain range; and
varying said preset temperature when said temperature of said target exceeds a certain value.

23. The assembly of claim 22, wherein said certain value is greater than one of 37° C., 37.5° C., 38° C., 38.5° C., 39° C., 39.5° C., and 40° C.

24. The assembly of claim 17, wherein said temperature reference system includes at least two sensing units, and wherein said control unit maintains said temperatures of said sensing units at two preset temperatures.

25. The assembly of claim 24, wherein at least one of said sensing units is one of a thermocouple, a thermistor, and a resistance temperature detector.

26. The assembly of claim 24, wherein said two preset temperatures are one of:
different from each other; and
identical to each other.

27. The assembly of claim 24, wherein said assembly performs one of:
keeping at least one of said two preset temperatures at a constant value;
varying at least one of said two preset temperatures according to a preset sequence;
varying at least one of said two preset temperatures according to a temperature of said ambient air;
varying at least one of said two preset temperatures when said temperature of said target falls between a certain value; and
varying at least one of said two preset temperatures when said temperature of said target exceeds a certain value.

28. The assembly of claim 17, wherein said at least one of said heating and cooling units is a Peltier element.

29. The assembly of claim 17, wherein said sensing unit is one of fixedly and detachably coupled to said IR camera.

30. The assembly of claim 17, wherein said sensing unit is disposed closer to said target than said IR camera when said IR camera detects said first and second amounts of said IR rays.

31. A temperature reference system for providing an IR camera with at least two reference temperatures which said IR camera uses in measuring and calibrating a temperature of a target who has an unknown body temperature comprising:
a temperature reference unit which includes a first surface, a second surface, and an interior between said first and second surfaces, wherein said second surface is exposed to an ambient air and to said IR camera, and wherein said second surface defines thereon a first pink body as well as a second pink body each of which has an IR-ray emissivity which is greater than 0.9;
a first sensing unit which is disposed close to said first pink body and measures a first temperature of said first pink body;
a second sensing unit which is disposed close to said second pink body and measures a second temperature of said second pink body;
at least one of a heating unit and a cooling unit each of which is disposed close to said first surface, wherein said heating unit generates heat, delivers said heat to said first and second pink bodies, and increases temperatures of said first and second pink bodies, and wherein said cooling unit absorbs heat from said first and second pink bodies, and decreases temperatures of said first and second pink bodies; and
a control unit which manipulating said at least one of said heating and cooling units in order to maintain said first temperature at a first preset temperature and to maintain said second temperature at a second preset temperature,
wherein said temperature reference system generates a first signal and a second signal each representing said first temperature and said second temperature, respectively, and sends said first and second signals to said IR camera,
whereby said temperature reference system allows said IR camera:
to detect a first amount of IR rays emitted by said first pink body;
to detect a second amount of IR rays emitted by said second pink body;
to obtain a first relationship between said first amount and said first temperature,
to obtain a second relationship between said second amount and said second temperature,
to detect a third amount of IR rays emitted by said target, and
to determine said temperature of said target using at least one of said first and second relationships.

32. The system of claim 31, wherein at least one of said first and second sensing units is one of a thermocouple, a thermistor, and a resistance temperature detector.

33. The system of claim 31, wherein said first sensing unit is disposed in one of:
on said second surface and right next to said first pink body;
on said second surface but away from said first pink body by a first lateral distance along a lateral direction which is parallel with said second surface;
immediately below said first pink body while contacting said first pink body; and
between said first and second surfaces and away from said first pink body by a first vertical distance along a vertical direction which is perpendicular to said lateral direction.

34. The system of claim 31, wherein at least one of said preset temperatures is a body temperature of one of a normal person, a person with a fever, and another person with a hyperthermia.

35. The system of claim 31, wherein one of said preset temperatures is a body temperature of a normal person, and wherein another of said preset temperatures is another body temperature of one of a person with a fever and another person with a hyperthermia.

36. The system of claim 31, wherein both of said preset temperatures are body temperatures of one of a person with a fever and another person with a hyperthermia.

37. The system of claim 31 further comprising a first outer layer, wherein said first outer layer sits on top of said first pink body, wherein said first outer layer is one of deposited on, coated over, and sprayed on said first pink body, and wherein said first outer performs at least one of:
minimizing absorption of one of water and water vapor therein;
repelling water therefrom;
resisting one of mechanical scratch, mechanical abrasion, and mechanical shock; and
minimizing reflection of said IR rays therefrom.

38. The system of claim 37, wherein said first outer layer has a thickness which is less than one of 3 mm, 2 mm, 1 mm, 0.5 mm, and 0.1 mm.

39. The system of claim 31, wherein said first preset temperature is between a first low temperature and a first high temperature, wherein said first low temperature is one of 35° C., 36° C., 37° C., 38° C., and 39° C., wherein said first high temperature is one of 37° C., 38° C., 39° C., 40° C., 41° C., and 42° C., and wherein said first low temperature is less than said first high temperature.

40. The system of claim 31, wherein said first preset temperature is determined by one of:
said temperature reference system;
a first user of said temperature reference system;
said IR camera;
a second user of said IR camera; and
a third user of said assembly.

41. The system of claim 31, wherein said system performs one of:
keeping said first preset temperature at a constant value;
varying said first preset temperature according to a preset sequence;
varying said first preset temperature according to a temperature of said ambient air;
varying said first preset temperature when said temperature of said target falls between a certain range; and
varying said first preset temperature when said temperature of said target exceeds a certain value, wherein said certain value is greater than one of 37° C., 37.5° C., 38° C., 38.5° C., 39° C., 39.5° C., and 40° C.

42. The assembly of claim 31, wherein said at least one of said heating and cooling units is a Peltier element.

43. The assembly of claim 31, wherein said temperature reference unit is one of fixedly and detachably coupled to said IR camera.

44. The assembly of claim 31, wherein said temperature reference unit is disposed closer to said target than said IR camera when said IR camera detects said first and second amounts of said IR rays.
